(19) United States
(12) Patent Application Publication
(10) Pub. No.: US 2007/0249736 A1
(43) Pub. Date: Oct. 25, 2007

(54) Titanium-Containing Silica Sol and Process for Producing the Same, Antifouling Film and Base Material with Ink-Receptive Layer, and Method for Reproducing Recording Base Material

(75) Inventors: Manabu Watanabe, Fukuoka (JP); Tatsuo Ogawa, Fukuoka (JP); Hiroyasu Nishida, Fukuoka (JP); Michio Komatsu, Fukuoka (JP)

Correspondence Address: THE WEBB LAW FIRM, P.C., 700 KOPPERS BUILDING, 436 SEVENTH AVENUE, PITTSBURGH, PA, 15219, US

(73) Assignee: Catalysts & Chemicals Industries Co., Ltd., Kawasaki-shi, Kanagawa (JP)

(21) Appl. No.: 11/661,799

(22) PCT Filed: Sep. 1, 2005
(86) PCT No.: PCT/JP05/16035

§ 371 Date: Mar. 1, 2007

(30) Foreign Application Priority Data
Sep. 2, 2004 (JP) 2004-256018

(51) Int. Cl. C01G 23/047; B41M 5/00; B41M 5/50; B41M 5/52; C01B 33/149

(52) U.S. Cl. 516/81

(57) ABSTRACT

It is an object of the present invention to provide a material which is applied to substrates by an easy and simple process, is applicable to substrates of a wide range and is capable of forming an antifouling film exhibiting excellent antifouling performance, and a substrate with an ink-receiving layer having excellent decoloring property. The titanium-containing silica sol of the invention includes (a) the following fine particles (a1) or the following fine particles (a2) and (b) a dispersion medium: (a1) titania fine particles having a mean particle diameter of 2 to 50 nm and porous silica fine particles having a mean particle diameter of 5 to 100 nm and a specific surface area, as determined by BET method, of not less than 300 m²/g, or (a2) porous silica fine particles obtained by surface-modifying surfaces of porous silica fine particles having a mean particle diameter of 5 to 100 nm and a specific surface area, as determined by BET method, of not less than 300 m²/g with a titanate compound.

### TECHNICAL FIELD

The present invention relates to fine particles that become raw materials of a general antifouling film-forming composition applicable to a wide range of fields, such as ship's bottoms, ceiling materials and fusuma (sliding doors). More particularly, the invention relates to a titanium-containing silica sol that becomes a raw material of an antifouling film-forming composition applicable to surfaces of substrates made of metals., glasses, wood, plastics, ceramics, papers, etc., and a process for preparing the same.

Further, the present invention relates to a substrate with an ink-receiving layer, which has an ink-receiving layer formed on a printing substrate, such as a film sheet made of a resin (e.g., PET, vinyl chloride), paper, a steel plate and cloth. Furthermore, the present invention relates to a method for recycling a recording substrate.

### BACKGROUND ART

Because underwater structures, such as ship's bottoms and fishing nets, are used in water, particularly seawater, over a long period of time, a great number of marine organisms such as ulva (green algae plant) adhere to the contact areas of the underwater structures with seawater and propagate there, and this sometimes induces bad fuel consumption of ships or lowering of the original function of fishing nets.

In order to solve the above problem, an antifouling agent is applied to surfaces of ship's bottoms and fishing nets for the purpose of preventing adhesion of marine organisms. More specifically, an antifouling agent composition obtained by adding a vehicle for properly eluting an antifouling agent, such as a hydrolyzable resin, to an organic antifouling agent is widely used. Further, a vehicle having antifouling property, such as a room temperature-curing silicone rubber, is also used as an antifouling agent. From such antifouling compositions, however, satisfactory antifouling property has not been obtained.

Although glasses, metals, wood, plastics and papers are widely used as various materials including ceiling materials, wall materials, floor materials and fusuma (sliding doors), organic dirt substances, such as dust, lamp black and sebaceous matter, adhere to them, and the original colors tend to fade. For the purpose of facilitating decomposition of the dirt having adhered to the material surfaces, there has been proposed, for example, a method of coating the above materials with a fluororesin in advance or a method of applying a silicone resin, an acrylic resin, a urethane resin or a fluorine-based paint.

In a patent document 1 (Japanese Patent Laid-Open Publication No. 72869/2001), a block copolymer having a polysiloxane block, an acrylic resin block and a metal-containing bond represented by -M-OCO-(GCOO)ᵣ—(CH₂)ₚ— (wherein M is a divalent metal atom, G is a divalent hydrocarbon group, r is 0 or 1, and p is an integer of 0 to 5), said metal-containing bond being present between the polysiloxane block and the acrylic resin block or present in the acrylic resin block, and having a specific intrinsic viscosity [η], and an antifouling film-forming composition comprising the above block copolymer are described. It is also described that according to the antifouling film-forming composition, a film exhibiting excellent antifouling property against aquatic life such as algae and shellfishes (e.g., mussel) can be formed on a surface of a substrate such as a fishing net. Further, it is also described that according to an antifouling method of a substrate described in the patent document 1, a film can be efficiently formed by impregnating or coating the substrate surface, which is to be brought into contact with seawater, with the antifouling agent composition, without causing environmental pollution.

In a patent document 2 (Japanese Patent Laid-Open Publication No. 19848/2001), an invention of an antifouling film-forming composition containing polyoxyalkylene modified silicone having a specific hydrophilicity-lipophilicity balance is disclosed, and it is described that according to an antifouling method of a substrate described in this document, a substrate surface in contact with seawater or fresh water or a surface of a fishing tackle, a fishing net, an underwater structure or the like can be effectively prevented from adhesion of algae or the like.

In a patent document 3 (Japanese Patent Laid-Open Publication No. 227804/1997), an antifouling coating agent having excellent antifouling effect, wherein a polymer containing units obtained by polymerizing an acrylate having a polyfluoroalkyl group and/or a methacrylate having a polyfluoroalkyl group, and a polyurethane compound having no isocyanate group are contained in an aqueous medium, are disclosed, and it is described that according to this antifouling coating agent, a film exhibiting excellent antifouling performance against various dirt substances can be formed on a substrate surface by an easy and simple process and the resulting film not only has antifouling property but also is excellent in hardness and appearance.

In a patent document 4 (Japanese Patent Laid-Open Publication No. 34422/2000), there is disclosed an invention that a resin material, which is obtained by graft polymerization of a specific silicone resin to a thermosetting polymerization type unsaturated ester in the presence of dicyclohexylcarbodiimide, is used as a resin material for preventing adhesion of aqueous dirt, and it is described that a cured product obtained from the resin material for preventing adhesion of aqueous dirt and a polyisocyante compound is used as an antifouling film against the aqueous dirt.

In a patent document 5 (Japanese Patent Laid-Open Publication No. 342359/2000), there is disclosed technique relating to an antifouling film composed of a graft polymer of a thermosetting polymerization type unsaturated ester and a silicone resin, and it is described that if the resin material is applied to a substrate made of a metal, a synthetic resin, wood, a ceramic, a glass or the like, the organic solvent is evaporated to form an antifouling film.

In a patent document 6 (Japanese Patent Laid-Open Publication No. 192021/2000), there is disclosed an invention relating to a hydrophilic anti-fogging antifouling substrate whose surface has been coated with a metal oxide film that has a surface profile having protrusions and depressions of 25 to 100 nm formed in the height direction and having their pitches of 10 to 100 A, and it is described that the metal oxide film has high hardness and excellent transparency and is capable of maintaining antifouling performance over a long period of time. Further, as a process for producing such a hydrophilic anti-fogging antifouling substrate, there is disclosed a process for forming a metal oxide film having regular protrusions and depressions on a substrate surface, comprising adding an organic metal compound for forming a matrix and ultra-fine particles showing water absorption property and/or photocatalytic activity to a solvent, homogeneously stirring and mixing them, applying the resulting solution onto a substrate surface, performing hydrolysis and polycondensation reaction and then performing drying or calcining (350 to 700° C.).

However, development of a material which is applied to a substrate by an easy and simple process, is applicable to substrates of a wide range and is capable of forming an antifouling film having excellent antifouling performance has been desired.

On the other hand, printing by ink jet system is becoming widespread in fields of various uses, because printing of the same image quality as that of conventional multicolor printing or color photographic system is possible, high-speed and multicolor printing can be easily made, and in case of a small number of copies, the cost is lower as compared with the conventional printing system. However, spreading of printing by ink jet system is a cause of mass consumption of papers such as plain paper and copying paper or printing substrates such as OHP sheet.

In a patent document 7 (Japanese Patent Laid-Open Publication No. 270225/2001), there is disclosed technique of an ink jet recording medium comprising a support and an ink-receiving layer formed thereon, wherein the ink-receiving layer contains a transition metal oxide (e.g., cerium oxide or titanium oxide), a surface of which has been coated with amorphous silica, and the transition metal oxide coated with amorphous silica has a mean secondary particle diameter of not less than 2.0 μm and not more than 8.0 μm, and it is described that this ink jet recording medium has excellent light resistance.

In a patent document 8 (Japanese Patent Laid-Open Publication No. 237538/2004), there is described an invention relating to a reversible recording medium which has, on at least a support, a reversible recording layer capable of forming a color-developed state and a decolored state by application of heat energy and is used for visibly confirming a color-developed image that is formed on the reversible recording layer by application of heat energy, wherein the support has transparency of such a degree as makes it possible to recognize the image formed on the recording layer from the support side and has a haze value of not less than 90%. It is also described that a sharp image can be formed by incorporating titanium oxide into the recording layer or a hiding layer.

In a patent document 9 (Japanese Patent No. 3,313,319), there is described an invention relating to a method for recycling a printing substrate, comprising carrying out printing on a substrate coated with a clear paint composition comprising titanium oxide fine particles having a mean particle diameter of 0.05 to 0.2 μm, a hydrolyzable silicon compound or a hydrolyzate of the silicon compound and/or a partial condensate of the hydrolyzable silicon compound, and a solvent, by the use of an ink composition comprising a dye whose coloring matter in the printed portion is decolored by irradiation with ultraviolet light, and then irradiating the resulting printed matter with ultraviolet light to decolor the printed portion.

However, development of much more excellent decoloring technique has been desired.
Patent document 1: Japanese Patent Laid-Open Publication No. 72869/2001
Patent document 2: Japanese Patent Laid-Open Publication No. 19848/2001
Patent document 3: Japanese Patent Laid-Open Publication No. 227804/1997
Patent document 4: Japanese Patent Laid-Open Publication No. 34422/2000
Patent document 5: Japanese Patent Laid-Open Publication No. 342359/2000
Patent document 6: Japanese Patent Laid-Open Publication No. 192021/2000
Patent document 7: Japanese Patent Laid-Open Publication No. 270225/2001
Patent document 8: Japanese Patent Laid-Open Publication No. 237538/2004
Patent document 9: Japanese Patent No. 3,313,319

### DISCLOSURE OF THE INVENTION

### Problems to be Solved by the Invention

The present invention is intended to solve such problems as described above, and it is an object of the present invention to provide a material which is applied to substrates by an easy and simple process, is applicable to substrates of a wide range and is capable of forming an antifouling film exhibiting excellent antifouling performance.

It is another object of the present invention to provide a substrate with an ink-receiving layer, a printed letter or a printed image being formed on which by means of ink jet printing or the like can be decolored, and a process for producing the substrate.

It is a further object of the present invention to enable recycling of a printing substrate having a printed letter or a printed image thereon.

### Means to Solve the Problems

In order to solve the above problems, the present inventors have earnestly studied, and as a result, they have found that an excellent antifouling film and an ink-receiving layer having excellent decoloring property can be formed by the use of a silica sol containing specific fine particles, that is, (a1) titania fine particles and porous silica fine particles or (a2) porous silica fine particles obtained by surface modification with a titanate compound. Based on the finding, the present invention has been accomplished.

The titanium-containing silica sol of the present invention comprises:
(a) the following fine particles (a1) or the following fine particles (a2):
(a1) titania fine particles having a mean particle diameter of 2 to 50 nm and porous silica fine particles having a mean particle diameter of 5 to 100 nm and a specific surface area, as determined by BET method, of not less than 300 m²/g,
(a2) porous silica fine particles obtained by surface-modifying surfaces of porous silica fine particles having a mean particle diameter of 5 to 100 nm and a specific surface area, as determined by BET method, of not less than 300 m²/g, with a titanate compound, and
(b) a dispersion medium.

The titanate compound is preferably represented by any one of the following formulas (1) to (3):
R¹¹ₙTiR¹²₄₋ₙ (1)
wherein n is an integer of 1 to 4;
R¹¹ is an alkoxy group having 1 to 6 carbon atoms, and when n is 2 or 3, two R¹¹ may be bonded to each other to form a ring structure represented by the following formula (1a), and further, two hydrogen atoms bonded to one carbon atom adjacent to an oxygen atom in the formula (1a) may be replaced with an oxygen atom to form a ring structure represented by the following formula (1b); and

R¹² is a hydrocarbon group having 1 to 5 carbon atoms or an organic group represented by the following formula (1c), (1d), (1e), (1f), (1g) or (1h):

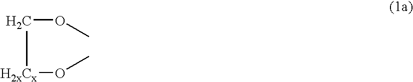

wherein x is an integer of 1 to 7,

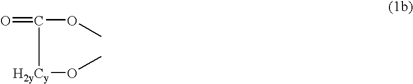

wherein y is an integer of 1 to 7,

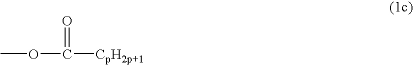

wherein p is an integer of 4 to 30,

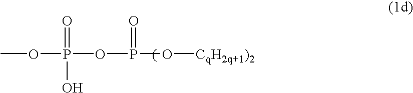

wherein q is an integer of 4 to 30,

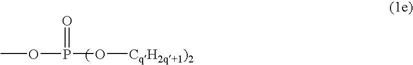

wherein q′ is an integer of 4 to 30,
—OCᵣH₂ᵣNHC_{r′}H_{2r′}NH₂ (1f)

wherein r and r′ are each an integer of 1 or greater, and r+r′ is 4 to 30,

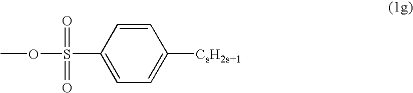

wherein s is an integer of 1 to 30,

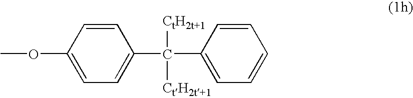

wherein t and t′ are each an integer of 1 to 30,
R²¹TiR²²R²³₂ (2)
wherein R²¹ is an alkoxy group having 1 to 4 carbon atoms, R²² is an organic group represented by the following formula (2a), and R²³ is an organic group represented by the following formula (2b):

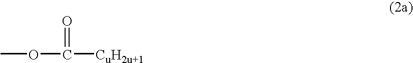

wherein u is an integer of 4 to 30,

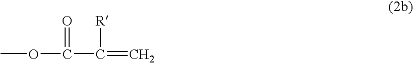

wherein R′ is a hydrogen atom or an alkyl group having 1 to 4 carbon atoms,
R³¹₄Ti.[P(OC_{2w}H_{2w+1})₂(OH)]₂ (3)

wherein R³¹ is an alkoxy group having 1 to 20 carbon atoms;
a part of hydrogen atoms in the alkoxy group may be replaced with an organic group having 4 to 12 carbon atoms and having at least one of an ether linkage and a double bond; and
w is an integer of 4 to 20.

The content of Si and Ti constituting the titania fine particles and the porous silica fine particles (a1) or the porous silica particles (a2) obtained by surface modification with the titanate compound is preferably in the range of 5 to 21,000 in terms of a SiO₂/TiO₂ weight ratio.

The surface electric charge of the porous silica fine particles is preferably in the range of 10 to 150 μeq based on 1 g of the fine particles.

The porous silica fine particles are preferably formed by coating surfaces of silica-alumina based silica fine particles of sol with silica and then subjecting them to dealuminum treatment.

The process for preparing a titanium-containing silica sol (a1s) comprising the titania fine particles and the porous silica fine particles (a1) and the dispersion medium (b) according to the present invention comprises mixing a titania sol which comprises titania fine particles having a mean particle diameter of 2 to 50 nm and a dispersion medium (b), and a silica sol which comprises porous silica fine particles having a mean particle diameter of 5 to 100 nm and a specific surface area, as determined by BET method, of not less than 300 m²/g and a dispersion medium (b) with each other.

The process for preparing a titanium-containing silica sol (a2s) comprising the porous silica fine particles (a2) obtained by surface-modifying surfaces of the above-mentioned porous silica fine particles with a titanate compound and the dispersion medium (b) according to the present invention comprises adding a titanate compound to a silica sol which comprises porous silica fine particles having a mean particle diameter of 5 to 100 nm and a specific surface area, as determined by BET method, of not less than 300 m²/g and a dispersion medium (b).

The antifouling film-forming composition of the present invention comprises the above-mentioned titanium-containing silica sol and, dispersed therein, a binder (c).

The ink-receiving layer-forming coating liquid of the present invention comprises the above-mentioned titanium-containing silica sol and, dispersed therein, a binder (c′).

The ink-receiving layer-forming coating liquid of the invention is preferably an ink-receiving layer-forming coating liquid wherein:
100 parts by weight of the fine particles (a1) or the fine particles (a2) and 5 to 7 parts by weight of the binder (c′) are contained,
the ratio between the weight (W_{B}) of the dispersion medium (b) and the total weight (W_{A}+W_{C′}) of the fine particles (a1) or the fine particles (a2) and the binder (c′), W_{B}:(W_{A}+W_{C′}), is 99.9 to 50:0.1 to 50 (total: 100), and
the content of Si and Ti constituting the fine particles (a1) or the fine particles (a2) is in the range of 5 to 21,000 in terms of a SiO₂/TiO₂ weight ratio.

The first process for preparing an ink-receiving layer-forming coating liquid according to the present invention comprises mixing a titanium-containing silica sol (a1s), which comprises the dispersion medium (b), dispersed therein, the titania fine particles and the porous silica fine particles (a1); the binder (c′); and, if necessary, the additional dispersion medium (b) with each other.

The second process for preparing an ink-receiving layer-forming coating liquid according to the present invention comprises mixing a titanium-containing silica sol (a2s), which comprises the dispersion medium (b), dispersed therein, the porous silica fine particles (a2) obtained by surface modification with a titanate compound; the binder (c′); and, if necessary, the additional dispersion medium (b) with each other.

The recording substrate with an ink-receiving layer of the present invention has an ink-receiving layer that is formed on a substrate surface, said ink-receiving layer containing the titania fine particles and the porous silica fine particles (a1) or the porous silica fine particles (a2) obtained by surface modification with a titanate compound.

The process for producing a recording substrate with an ink-receiving layer according to the present invention comprises coating a substrate surface with the above-mentioned ink-receiving layer-forming coating liquid and then drying the coating liquid.

The method for recycling a recording substrate according to the present invention comprises performing printing on the recording substrate with an ink-receiving layer using an ink to form a printed letter or a printed image and then irradiating the printed letter or the printed image with ultraviolet light or bringing it into contact with an acid gas or ozone to decolor the printed letter or the printed image.

### Effect of the Invention

By using the titanium-containing silica sol of the invention, antifouling films can be easily formed on surfaces of metals, glasses, wood, plastics, ceramics, papers or the like, and the antifouling films exert excellent antifouling effect.

In the case where the antifouling film is applied to a surface of a ship's bottom, adhesion of green algae can be inhibited. In the case where the antifouling film is applied to a surface of a ceiling material, a wall material, paper or the like, even if organic dirt substances, such as dust, lamp black and sebaceous matter, adhere to the antifouling film, the dirt substances present on the substrate surface can be decomposed by irradiation with ultraviolet light or contact with an acid gas. When the substrate is a wall material or paper, decomposition effect is exerted on the dirt given by an ink, such as scribbling, and the dirt can be removed.

The recording substrate with an ink-receiving layer of the invention is produced by applying the ink-receiving layer-forming coating liquid of the invention and drying the coating liquid, and a printed letter or a printed image formed on this recording substrate by means of ink jet printing can be decolored by irradiation with ultraviolet light or contact with an acid gas or ozone.

By using of the method for recycling a recording substrate of the invention, mass consumption of papers, such as plain paper and copying paper, and printing substrates, such as OHP sheet, can be inhibited.

### BEST MODE FOR CARRYING OUT THE INVENTION

The titanium-containing silica sol, the process for preparing the silica sol, the antifouling film, the substrate with an ink-receiving layer and the method for recycling a recording substrate according to the present invention are described in detail hereinafter.

The term “antifouling” used in this specification means both of prevention of adhesion of dirt substances and decomposition of dirt substances having adhered.

In this specification, further, removal of a printed letter or a printed image formed on a surface of the recording substrate with an ink-receiving layer by irradiating it with ultraviolet light or bringing it into contact with an acid gas or ozone is referred to as “decoloring”, and such property is referred to as “decoloring property”.

### Titanium-containing Silica Sol

The titanium-containing silica sol of the invention comprises (a1) titania fine particles and porous silica fine particles (also referred to as “fine particles (a1)” simply in this specification) or (a2) porous silica fine particles obtained by surface modification with a titanate compound (also referred to as “fine particles (a2)” simply in this specification) and (b) a dispersion medium. Therefore, embodiments of the titanium-containing silica sol of the invention include a titanium-containing silica sol comprising the titania fine particles and the porous fine particles (a1) and the dispersion medium (b) (also referred to as a “titanium-containing silica sol (a1s)” in this specification) and a titanium-containing silica sol comprising the surface-modified porous silica fine particles (a2) and the dispersion medium (b) (also referred to as a “titanium-containing silica sol (a2s)” in this specification).

(a1) Titania Fine Particles and Porous Silica Fine Particles

Titania Fine Particles

The titania fine particles used in the invention exert catalytic effect on the oxidation-reduction reaction of an organic substance upon irradiation with light having specific energy such as ultraviolet light. The titania fine particles may be any of amorphous titania fine particles and crystalline titania fine particles, and their crystal form may be any of anatase type, rutile type, brookite type and a mixture thereof provided that they are crystalline titanium dioxide particles. In the present invention, the titania fine particles in the form of a titania sol are mixed with a silica sol in which porous silica fine particles are dispersed.

The mean particle diameter of the titania fine particles is in the range of 2 to 50 nm, preferably 5 to 40 nm.

In the case where the titanium-containing silica sol is used as a raw material of an antifouling film-forming composition, if the mean particle diameter is less than the lower limit of the above range, dispersion stability of the titania sol or the titanium-containing silica sol of the invention is sometimes deteriorated, and if the mean particle diameter is more than the upper limit of the above range, transparency of an antifouling film formed using the titanium-containing silica sol of the invention is sometimes lowered, and hence, deterioration of appearance such as darkening sometimes takes place on a surface of a substrate to which the antifouling film has been applied, or photcatalytic function of the titania fine particles is not sufficiently exerted occasionally.

In the case where the titanium-containing silica sol is used as a raw material of an ink-receiving layer-forming coating liquid, if the mean particle diameter of the titania fine particles is less than the lower limit of the above range, dispersion stability of the titania sol, the titanium-containing silica sol or the ink-receiving layer-forming coating liquid is sometimes deteriorated, and if the mean particle diameter is more than the upper limit of the above range, transparency of a surface of the recording substrate with an ink-receiving layer is sometimes lowered, and hence, deterioration of appearance such as darkening sometimes takes place on a surface of the recording substrate with an ink-receiving layer, or decoloring effect based on the photocatalytic function of the titania fine particles is not sufficiently exerted occasionally.

The specific surface area of the titania fine particles is not specifically restricted, and any titania fine particles are applicable to the present invention provided that they have the aforesaid mean particle diameter.

The particle properties of the titania fine particles are not specifically restricted, and the titania fine particles may be any of spherical particles and non-spherical particles, and may be porous particles.

As a starting material of the titania sol in which the titania fine particles are dispersed, a titania compound, such as titanium sulfate or titanium chloride, or powdery titania whose crystal form is anatase type, rutile type and/or brookite type is employed. When a titanium compound or a titania powder having a mean particle diameter of more than 2 to 50 nm is used as a starting material, the compound or the powder is pulverized to decrease the particle diameters prior to use. As the titania powder, commercially available titanium oxide of ultra-fine particles may be used as it is or after calcined.

Porous Silica Fine Particles

The silica fine particles used in the invention are porous silica fine particles, namely, silica fine particles having a large specific surface area, and have a specific surface area, as measured by BET method, of not less than 300 m²/g, preferably not less than 400 m²/g.

An antifouling film comprising a titanium-containing silica sol containing porous silica fine particles having a specific surface area of the above range and a titania sol or comprising a titanium-containing silica sol containing porous silica fine particles obtained by surface-modifying the porous silica fine particles with a titanate compound can exert excellent antifouling effect when it is irradiated with ultraviolet light or brought into contact with an acid gas.

Further, an ink-receiving layer formed by the use of an ink-receiving layer-forming coating liquid comprising a titanium-containing silica sol containing porous silica fine particles having a specific surface area of the above range and a titania sol or comprising a titanium-containing silica sol containing porous silica fine particles obtained by surface-modifying the porous silica fine particles with a titanate compound can exert excellent decoloring effect when it is irradiated with ultraviolet light or brought into contact with an acid gas.

The mean particle diameter of the porous silica fine particles is in the range of 5 to 100 nm, preferably 10 to 50 nm.

In the case where the titanium-containing silica sol is used as a raw material of an antifouling film-forming composition, if the mean particle diameter is less than the lower limit of the above range, dispersion stability of a sol in which the porous silica fine particles are dispersed or the titanium-containing silica sol tends to be deteriorated, and if the mean particle diameter is more than the upper limit of the above range, transparency of an antifouling film formed using the titanium-containing silica sol is sometimes lowered, and hence, deterioration of appearance such as darkening sometimes takes place on a surface of a substrate where the antifouling film has been formed, or photocatalytic function of titania fine particles coexisting with the porous silica fine particles is not sufficiently exerted occasionally.

In the case where the titanium-containing silica sol is used as a raw material of an ink-receiving layer-forming coating liquid, if the mean particle diameter is less than the lower limit of the above range, dispersion stability of a sol in which the porous silica fine particles are dispersed, the titanium-containing silica sol or the ink-receiving layer-forming coating liquid tends to be deteriorated, and if the mean particle diameter is more than the upper limit of the above range, transparency of the resulting ink-receiving layer is sometimes lowered, and hence, deterioration of appearance of the substrate with an ink-receiving layer sometimes takes place, or decoloring property based on the photocatalytic function of titania fine particles coexisting with the porous silica fine particles is not sufficiently exerted occasionally.

The surface electric charge of the porous silica fine particles is preferably in the range of 10 to 150 μeq/g.

In the case where the titanium-containing silica sol is used as a raw material of an antifouling film-forming composition, if the surface electric charge is less than 10 μeq/g, a sol in which the porous silica fine particles are dispersed or the titanium-containing silica sol of the invention tends to become unstable, and if the surface electric charge exceeds 150 μeq/g, viscosity of the sol tends to become high, and viscosity of an antifouling film-forming composition containing the porous silica fine particles as main components also becomes high, so that it becomes difficult to form a uniform film.

By the use of the porous silica fine particles having a surface electric charge of 10 to 150 μeq/g, a film of high transparency can be formed, and besides, when a film is formed by mixing a sol containing the porous silica fine particles and a titania sol with each other, then applying the mixture to a substrate and drying the mixture, the fine particles in the sol are hardly aggregated because of large surface electric charge of the porous silica fine particles, and hence, a film in which titania fine particles are homogeneously dispersed is apt to be formed.

In the case where the titanium-containing silica sol is used as a raw material of an ink-receiving layer-forming coating liquid, if the surface electric charge is less than 10 μeq/g, a sol in which the porous silica fine particles are dispersed, the titanium-containing silica sol or the ink-receiving layer-forming coating liquid tends to become unstable, and if the surface electric charge exceeds 150 μeq/g, viscosity of a sol in which the porous silica fine particles are dispersed or the titanium-containing silica sol tends to become high, and viscosity of the ink-receiving layer-forming coating liquid containing the titanium-containing silica sol as a main component also becomes high, so that it becomes difficult to form a uniform film.

On the other hand, by the use of the porous silica fine particles having a surface electric charge of 10 to 150 μeq/g, an ink-receiving layer having high transparency can be formed. Further, because the surface electric charge of the porous silica fine particles is pertinent, the fine particles are hardly aggregated and the titania fine particles are homogeneously dispersed in the titanium-containing sol and in the ink-receiving layer-forming coating liquid, so that also in an ink-receiving layer formed by applying the ink-receiving layer-forming coating liquid onto a substrate and drying the coating liquid, the titania fine particles are sufficiently dispersed. As a result, the recording substrate with an ink-receiving layer of the invention exhibits excellent decoloring property.

Process for Preparing Porous Silica Fine Particles

A process for preparing the porous silica fine particles used in the invention is not specifically restricted, and a publicly known preparation process is applicable. The preparation process is, for example, such a process for preparing porous silica fine particles as disclosed in Japanese Patent Laid-Open Publication No. 233611/2001, which is characterized by removing a specific element from silica fine particles that also contain an inorganic compound other than silica. Preferably, there can be mentioned such a process for preparing porous silica fine particles as described below, which comprises coating surfaces of silica-alumina based silica fine particles functioning as core particles and dispersed in water, with silica and then carrying out dealuminum treatment.

(I) Core Particles

As the core particles, fine particles such as silica-alumina based silica fine particles are used, and they are usually used in the form of a dispersion of sol. Such a dispersion of sol is obtained by a publicly known process. The dispersion of sol is obtained by, for example, adding an aqueous solution of a silicate and/or a silicic acid solution, and an aqueous solution of an inorganic compound such as alkali-soluble sodium aluminate, at the same time, to an alkali aqueous solution of pH 10 or more or an alkali aqueous solution of pH 10 or more in which SiO₂—Al₂O₃ (composite oxide of Si and Al) as seed particles are optionally dispersed. The dispersion of the seed particles is obtained by adding an acid or an alkali to a metal salt corresponding to SiO₂—Al₂O₃, a mixture of the metal salt, a metal alkoxide or the like and hydrolyzing the metal salt or the like, with optionally heating or with optionally growing the seeds under heating.

(II) Formation of Silica Coating Layer

As a raw material of a silica coating layer, which is added to the dispersion of sol of silica-alumina based silica fine particles, a silicic acid solution obtained by dealkalizing an alkali metal salt of Si (water glass) is particularly preferable. In the case where the dispersion medium for the core particles is water alone or a mixture of water and an organic compound having a high ratio of water to the organic compound, coating with a silicic acid solution is also possible. In case of the coating with a silicic acid solution, a given amount of a silicic acid solution is added to the dispersion, and at the same time, an alkali is added to polymerize silicic acid and thereby deposit the silicic acid on the core particle surfaces. When the silica-alumina based silica fine particles are used as the core particles, the amount of the silicic acid added is determined so that the later-described dealuminum treatment by the addition of an acid should become possible.

Further, a hydrolyzable organosilicon compound is also employable as the silica raw material. As the hydrolyzable organosilicon compound, an alkoxysilane represented by the formula RₙSi(OR′)₄₋ₙ (wherein R and R′ are a hydrocarbon group, such as an alkyl group, an aryl group, a vinyl group or an acrylic group, and n is 0, 1, 2 or 3) is employable, and particularly preferred examples thereof include tetraalkoxysilanes, such as tetramethoxysilane, tetraethoxysilane and tetraisopropoxysilane.

As the addition method, there can be mentioned a method wherein a solution, which is obtained by adding a small amount of an alkali or an acid as a catalyst to a mixed solution of the alkoxysilane, pure water and an alcohol, is added to the dispersion of the core particles to deposit silicic acid that is formed by hydrolysis of the alkoxysilane on the surfaces of the core particles. In this method, the alkoxysilane, the alcohol and the catalyst may be added to the dispersion at the same time. Examples of the alkali catalysts employable in this method include ammonia, hydroxides of alkali metals and amines. Examples of the acid catalysts employable in this method include various inorganic acids and organic acids.

It is also possible to carry out coating by the use of the alkoxysilane and the silicic acid solution in combination. Further, it is also possible to carry out coating by the use of an inorganic compound other than the silica source in combination when needed, and the aforesaid alkali-soluble inorganic compound used for the preparation of the core particles is employable. The amounts of the silica raw material and the inorganic compound that is added when needed are preferably in such a range that a metal soluble in an acid solvent can be eluted after coating of the core particles. If the coating weight is too small, the core particles are sometimes dissolved or disintegrated. The thickness of the coating layer is suitably in the range of usually 1 nm to 10 nm.

(III) Dealuminum Treatment

From the core particle having a silica coating layer formed thereon, a part or the whole of aluminum that constitutes the core particle is removed, whereby a hollow spherical fine particle having a cavity inside the coating layer that is a shell can be produced. In order to remove a part or the whole of aluminum that constitutes the core particle, a method of adding an inorganic mineral acid or an organic acid to the core particle dispersion to dissolve and thereby remove aluminum or a method of brining the core particle dispersion and a cation-exchange resin into contact with each other to perform ion exchange and thereby remove aluminum can be exemplified.

In the removal of aluminum, the concentration of the core particles in the core particle dispersion varies depending upon the treatment temperature, but it is desirably in the range of 0.1 to 50% by weight, preferably 0.5 to 25% by weight, in terms of an oxide. If the concentration is less than 0.1% by weight, there is possibility of occurrence of dissolution of silica that constitutes the silica coating layer, and besides, treatment efficiency is bad because of low concentration. If the concentration of the core particles exceeds 50% by weight, it becomes difficult to remove a necessary amount of aluminum by treatments of a small number of times.

Removal of aluminum is preferably carried out until the weight ratio of Al₂O₃ in the porous silica fine particles obtained by the removal of aluminum, that is, Al₂O₃/[Al₂O₃+SiO₂]×100, becomes 0.01 to 5% by weight. The dispersion obtained by removal of aluminum can be cleaned by a publicly known cleaning method such as ultrafiltration. If necessary, the dispersion medium can be replaced with an organic dispersion medium. In the silica-based fine particles dispersed in the resulting dispersion sol, the shell is constituted of the porous silica layer, and in the cavity inside, a solvent and/or a gas is contained. When aluminum is not completely removed from the core particle, a porous substance remains in the cavity.

(b) Dispersion Medium

Examples of the dispersion media (b) employable in the invention include:

water;

alcohols, such as methanol, ethanol, isopropanol, n-butanol and methylisocarbinol;

ketones, such as acetone, 2-butanone, ethyl amyl ketone, diacetone alcohol, isophorone and cyclohexanone;

amides, such as N,N-dimethylformamide and N,N-dimethylacetamide;

ethers, such as diethyl ether, isopropyl ether, tetrahydrofuran, 1,4-dioxane and 3,4-dihydro-2H-pyran;

glycol ethers, such as 2-methoxyethanol, 2-ethoxyethanol, 2-butoxyethanol and ethylene glycol dimethyl ether;

glycol ether acetates, such as 2-methoxyethyl acetate, 2-ethoxyethyl acetate and 2-butoxyethyl acetate;

esters, such as methyl acetate, ethyl acetate, isobutyl acetate, amyl acetate, ethyl lactate and ethylene carbonate;

aromatic hydrocarbons, such as benzene, toluene and xylene;

aliphatic hydrocarbons, such as hexane, heptane, isooctane and cyclohexane;

halogenated hydrocarbons, such as methylene chloride, 1,2-dichloroethane, dichloropropane and chlorobenzene;

sulfoxides, such as dimethyl sulfoxide; and

pyrrolidones, such as N-methyl-2-pyrrolidone and N-octyl-2-pyrrolidone.

From these dispersion media, an appropriate dispersion medium is selected according to compatibility with a binder used for preparing the later-described antifouling film-forming composition or ink-receiving layer-forming coating liquid.

The above dispersion media may be used singly or in combination of two or more kinds.

In the case where the dispersion medium (b) is used as a raw material of the later-described ink-receiving layer-forming coating liquid, the dispersion medium (b) is sometimes referred to as a “solvent (b′) consisting of water and/or an organic solvent” in this specification.

Process for Preparing Titanium-containing Silica Sol Comprising Titania Fine Particles and Porous Silica Fine Particles (a1) and Dispersion Medium (b)

The titanium-containing silica sol of the invention comprising the titania fine particles and the porous silica fine particles (a1) and the dispersion medium (b) (titanium-containing silica sol (a1s)) can be obtained by, for example, dispersing a mixture of the titania fine particles and the porous silica fine particles in the dispersion medium, and it is preferably prepared by mixing a titania sol comprising the titania fine particles and the dispersion medium (b) and a silica sol comprising the porous silica fine particles and the dispersion medium (b) with each other.

The weight ratio of Si in the porous silica fine particles constituting the titanium-containing silica sol of the invention to Ti in the titania fine particles constituting the titanium-containing silica sol of the invention is in the range of preferably 5 to 21,000, more preferably 100 to 16,000, in terms of a weight ratio of SiO₂ to TiO₂ (SiO₂/TiO₂). If SiO₂/TiO₂ is less than 5, transparency of the, titanium-containing silica sol or the later-described ink-receiving layer tends to be lowered.

In the case where the titanium-containing sol is used as a raw material of an antifouling film-forming composition, if SiO₂/TiO₂ exceeds 21,000, antifouling effect based on the photocatalytic action of the titania fine particles tends to be lowered, and hence, the time required for decomposition of dirt tends to be markedly increased. In the case where the titanium-containing sol is used as a raw material of an ink-receiving layer-forming coating liquid, if SiO₂/TiO₂ exceeds 21,000, decoloring effect based on the photocatalytic action of the titania fine particles is lowered, and hence, the time required for decoloring a printed letter or a printed image tends to be markedly increased.

(a2) Porous Silica Fine Particles Obtained by Surface Modification with Titanate Compound

In the porous silica fine particles obtained by surface modification with a titanate compound (also referred to as “surface-modified porous silica fine particles (a2)” hereinafter), which are used in the invention, the surfaces of the porous silica fine particles are presumed to be covered with a titania-based film having a structure represented by, for example, the following formula (4), and it is thought that this film exerts the same photocatalytic action as that of the titania fine particles.

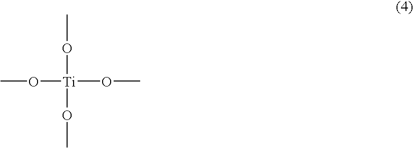

As the titanate compound, a compound having a hydrolyzable group containing a Ti atom is employed, and examples of such compounds include a tetraalkoxytitanium compound, a titanium acylate compound, a titanium chelate compound and a titanate-based coupling agent. Of these, a titanate compound represented by any one of the following formulas (1) to (3) is particularly preferable.
R¹¹ₙTiR¹² (1)
wherein n is an integer of 1 to 4;

R¹¹ is an alkoxy group having 1 to 6 carbon atoms, and when n is 2 or 3, two R¹¹ may be bonded to each other to form a ring structure represented by the following formula (1a), and further, two hydrogen atoms bonded to one carbon atom adjacent to an oxygen atom in the formula (1a) may be replaced with an oxygen atom to form a ring structure represented by the following formula (1b); and

R¹² is a hydrocarbon group having 1 to 5 carbon atoms or an organic group represented by the following formula (1c), (1d), (1e), (1f), (1g) or (1h).

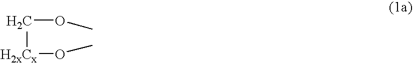

wherein x is an integer of 1 to 7, preferably an integer of 1 to 3.

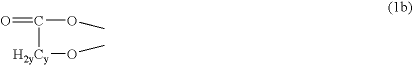

wherein y is an integer of 1 to 7, preferably an integer of 1 to 3.

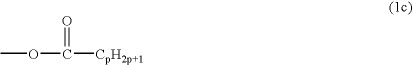

wherein p is an integer of 4 to 30, preferably an integer of 5 to 20.

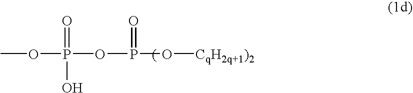

wherein q is an integer of 4 to 30, preferably an integer of 5 to 20.

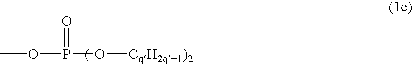

wherein q′ is an integer of 4 to 30, preferably an integer of 5 to 20.
—OCᵣH₂ᵣNHC_{r′}H_{2r′}NH₂ (1f)

wherein r and r′ are each an integer of 1 or greater, and r+r′ is an integer of 4 to 30, preferably an integer of 4 to 20.

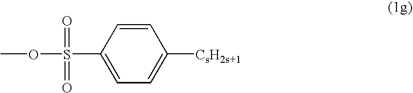

wherein s is an integer of 1 to 30, preferably an integer of 5 to 20.

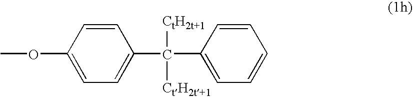

wherein t and t′ are each an integer of 1 to 30, preferably an integer of 1 to 3.
R²¹TiR²²R²³₂ (2)
wherein R²¹ is an alkoxy group having 1 to 4 carbon atoms, R²² is an organic group represented by the following formula (2a), and R²³ is an organic group represented by the following formula (2b).

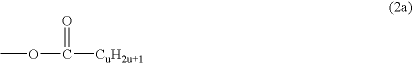

wherein u is an integer of 4 to 30, preferably an integer of 5 to 20.

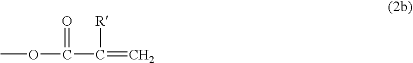

wherein R′ is a hydrogen atom or an alkyl group having 1 to 4 carbon atoms.
R³¹₄Ti.[P(OC_{2w}H_{2w+1})₂(OH)]₂ (3)
wherein R³¹ is an alkoxy group having 1 to 20 carbon atoms, preferably 2 to 10 carbon atoms,
a part of hydrogen atoms in the alkoxy group may be replaced with an organic group having 1 to 12 carbon atoms, preferably 4 to 8 carbon atoms, and having at least one of an ether linkage and a double bond, and
w is an integer of 4 to 20, preferably an integer of 5 to 20.

Examples of the R¹¹ include a methoxy group, an ethoxy group, a n-propoxy group, an isopropoxy group, a n-butoxy group and a t-butoxy group.

Examples of the R¹² include a methyl group, an ethyl group, a n-propyl group, an isopropyl group, a t-butyl group, an n-butyl group and a n-pentyl group.

Examples of the R²¹ include a methoxy group, an ethoxy group, a n-propoxy group, an isopropoxy group, a n-butoxy group and a t-butoxy group.

Examples of the R³¹ include a methoxy group, an ethoxy group, a n-propoxy group, an isopropoxy group, a n-butoxy group, a t-butoxy group, a substituted propoxy group and a substituted butoxy group.

Examples of such titanate compounds include isopropyl triisostearoyl titanate, isopropyl tris(dioctylpyrophosphato)titanate, isopropyl tri(N-amylethyl-aminoethyl)titanate, tetra(2,2-diallyloxymethyl-1-butyl)bis(ditridecyl)phosphite titanate, bis(dioctylpyrophosphato)oxyacetate titanate, bis(dioctylpyrophosphato)ethylene titanate, isopropyl tridecylbenzenesulfonyl titanate and tetraisopropoxytitanate.

The specific surface area of the porous silica fine particles before surface modification with the titanate compound, as measured by BET method, is not less than 300 m²/g, preferably not less than 350 m²/g. If the specific surface area is less than 300 m²/g, the amount of titanate to coat the surfaces of the porous silica fine particle is decreased, and hence, excellent antifouling effect and decoloring effect based on the photoactivity of the film tend to be hardly exerted.

The mean particle diameter of the porous silica fine particles before surface modification with the titanate compound is in the range of 5 to 100 nm, preferably 10 to 90 nm. If the mean particle diameter is less than the lower limit of the above range, dispersion stability of the sol is sometimes lowered, and trouble sometimes occurs in mixing with a binder or the like.

In the case where the titanium-containing sol is used as a raw material of an antifouling film-forming composition, if the mean particle diameter is more than the upper limit of the above range, transparency of an antifouling film formed by the use of the titanium-containing silica sol is sometimes lowered, and hence, deterioration of appearance such as darkening sometimes takes place on a surface of a substrate having the antifouling film, or photocatalytic function is not sufficiently exerted occasionally. In the case where the titanium-containing silica sol is used as a raw material of an ink-receiving layer-forming coating liquid, if the mean particle diameter is more than the upper limit of the above range, transparency of an ink-receiving layer formed by the use of the titanium-containing silica sol is sometimes lowered, and hence, deterioration of appearance such as darkening sometimes takes place on a surface of a printing substrate having an ink-receiving layer formed thereon, or decoloring function is not sufficiently exerted occasionally.

The surface electric charge of the porous silica fine particles before surface modification with the titanate compound is preferably in the range of 10 to 150 μeq/g. If the surface electric charge is less than 10 μeq/g, dispersion properties of the sol tend to become unstable. If the surface electric charge exceeds 150 μeq/g, viscosity of the sol becomes high, and viscosity of the later-described antifouling film-forming composition containing the porous silica fine particles as main components also becomes high, so that it becomes difficult to form a uniform film, or viscosity of an ink-receiving layer-forming coating liquid containing the porous silica fine particles as main components also becomes high, so that it becomes difficult to form a uniform receiving layer.

The weight ratio of Si to Ti contained in the surface-modified porous silica fine particles (a2) is in the range of preferably 5 to 21,000, more preferably 100 to 16,000, in terms of a weight ratio of SiO₂ to TiO₂ (SiO₂/TiO₂). If SiO₂/TiO₂ is less than 5, transparency of the titanium-containing silica sol tends to be lowered.

In the case where the titanium-containing sol is used as a raw material of an antifouling film-forming composition, if SiO₂/TiO₂ exceeds 21,000, antifouling effect based on the photocatalytic action of the titania-based film tends to be lowered, and hence, the time required for decomposition of dirt tends to be markedly increased. In the case where the titanium-containing sol is used as a raw material of an ink-receiving layer-forming coating liquid, if SiO₂/TiO₂ exceeds 21,000, decoloring effect based on the photocatalytic action of the titania fine particles tends to be lowered, and hence, the time required for decoloring a printed letter or a printed image tends to be markedly increased.

Process for Preparing Titanium-containing Silica Sol Comprising Surface-modified Porous Silica Fine Particles (a2) and Dispersion Medium (b)

The titanium-containing silica sol of the invention comprising the surface-modified porous silica fine particles (a2) and the dispersion medium (b) (titanium-containing silica sol (a2s)) can be preferably obtained by adding a titanate compound to a silica sol comprising the porous silica fine particles and water or water and an organic dispersion medium with stirring the silica sol by a high-speed stirring machine, at a temperature of not lower than 15° C. over a period of 10 minutes to 2 hours. If the stirring is weak, the titanate compound is sometimes hydrolyzed and aggregated.

The compounding ratio of the porous silica fine particles to the titanate compound, in terms of a weight ratio of SiO₂ to TiO₂ (SiO₂/TiO₂), is in the range of preferably 5 to 21,000, more preferably 100 to 16,000. If SiO₂/TiO₂ is less than 5, transparency of the titanium-containing silica sol tends to be lowered. On the other hand, if SiO₂/TiO₂ exceeds 21,000, fouling substance decomposition effect based on the photocatalytic action of the titania-based film, that is, antifouling effect, tends to be lowered, and hence, the time required for decomposition of dirt tends to be markedly increased.

Such surface-modified porous silica fine particles (a2) have excellent photocatalytic function, and even if dirt that is an organic compound adheres to a surface of a substrate on which an antifouling film containing the fine particles has been formed, the dirt is decomposed by irradiation with ultraviolet light and is further decomposed also by the contact with an acid gas, ozone or the like.

Moreover, the surface-modified porous silica fine. particles (a2) have excellent decoloring function based on the photocatalytic action, and even if a letter or an image is printed with an ink on a surface of a printing substrate on which an ink-receiving layer containing the fine particles has been formed, the printed letter or the printed image is decolored by irradiation with ultraviolet light and also by the contact with an acid gas, ozone or the like.

Titanium-containing Silica Sol

The titanium-containing silica sol of the invention comprises the titania fine particles and the porous silica fine particles (a1) or the surface-modified porous silica fine particles (a2) and the dispersion medium (b), and can be used as a titanium-containing silica sol that is added to the later-described antifouling film-forming composition or ink-receiving layer-forming coating liquid.

The weight ratio of Si to Ti in the titanium-containing silica sol of the invention is in the range of preferably 5 to 21,000, more preferably 100 to 16,000, in terms of a weight ratio of SiO₂ to TiO₂ (SiO₂/TiO₂). If SiO₂/TiO₂ is less than 5, transparency of the titanium-containing silica sol tends to be lowered. On the other hand, if SiO₂/TiO₂ exceeds 21,000, antifouling effect based on the photocatalytic action of the titania-based film tends to be lowered, and hence, the time required for decomposition of dirt tends to be markedly increased.

The titanium-containing silica sol (a1s) comprising the titania fine particles and the porous silica fine particles (a1) and the dispersion medium (b) and the titanium-containing silica sol (a2s) comprising the surface-modified porous silica fine particles (a2) and the dispersion medium (b) may be mixed and used, when needed.

Although the solids concentration of the titanium-containing silica sol of the invention is usually in the range of 1 to 30% by weight, the solids concentration is not limited to this range, and for the purpose of blending the sol with the later-described binder component or controlling the film thickness of the later-described antifouling film or ink-receiving layer, the solids concentration is desired to be properly controlled.

The titanium-containing silica sol of the invention may further contain antiseptic agent, mildew-proofing agent, anti-fungus agent, colorant, fading preventing agent, dispersant, surface active agent, etc., when needed, within limits not detrimental to the objects of the present invention.

Next, an antifouling film-forming composition using the titanium-containing silica sol of the invention, an antifouling film, an ink-receiving layer-forming coating liquid, a recording substrate with an ink-receiving layer, a process for producing the same, and a method for recycling a recording substrate are described.

### Antifouling Film-forming Composition

By using the titanium-containing silica sol of the invention, an antifouling film-forming composition comprising the titanium-containing silica sol and a binder (c) can be prepared.

As the binder, an organic resin, cellulose, starch or an inorganic compound is employable. Examples of the organic resins include a styrene/maleic anhydride copolymer, a styrene/acrylic acid alkyl ester copolymer, polyvinyl alcohol, an ethylene/vinyl alcohol copolymer containing a silanol group, polyvinyl pyrrolidone, an ethylene/vinyl acetate copolymer, methyl ethyl cellulose, polyacrylic acid soda, polyethylene polyamine, polyester, polyacrylamide, a vinylpyrrolidone/vinyl acetate copolymer, a cation-modified polyurethane resin and a tertiary nitrogen-containing acrylic resin (refer to Japanese Patent Laid-Open Publication No. 148292/1987). Examples of the celluloses include bio-cellulose. Examples of the inorganic compounds include sodium silicate, potassium silicate, lithium silicate, mixtures thereof, a hydrolyzate of organic silicon, an organic-modified inorganic compound and ceramics.

The titanium-containing silica sol and the binder (c) are preferably mixed in a solids content weight ratio (titanium-containing silica sol:binder (c)) of 95 to 40:5 to 60 (total of both components: 100).

The antifouling film-forming composition may further contain fine particles (e.g., antimony-based fine particles, silica-based fine particles, alumina-based fine particles, zirconia fine particles, calcium carbonate, clay, titanium oxide, zinc oxide and talc), ink setting agent, ultraviolet light absorber, surface active agent, anti-fungus agent, etc., when needed, in addition to the titanium-containing silica sol of the invention.

### Antifouling Film

An antifouling film can be formed by forming a layer on a substrate using the antifouling film-forming composition and then drying the layer. When the antifouling film-forming composition is applied onto a substrate to form an antifouling film, the application method is not specifically restricted, and an appropriate application method is adopted according to the type of the substrate. Specifically, publicly known methods, such as spraying, brushing, dipping, roll coater method, blade coater method, bar coater method and curtain coater method, are adoptable. For drying the layer, publicly known methods such as air drying are adoptable.

The antifouling film can be formed on substrates of a wide range, and examples of the substrates include boards with coating films formed from various coating materials, metals, wood, ceramics, plastics, papers such as pulp paper and synthetic paper, OHP sheet, resin films, cloths, metal foils, glasses and composite materials thereof.

The coating weight of the antifouling film-forming composition has only to be properly determined according to the substrate and the use application, and for example, when the substrate is printing paper or OHP sheet, the coating weight is in the range of usually 1 to 50 g/m², preferably 2 to 30 g/m², in terms of solids content.

Antifouling Method

Prevention of fouling of a substrate by the use of the antifouling film is achieved in the following manner. That is, when a dirt substance that is an organic compound has adhered to the antifouling film on a substrate to cause darkening or coloring, the antifouling film is irradiated with light such as ultraviolet light or brought into contact with an acid gas or ozone, whereby the dirt substance is decomposed and removed.

Of the above means, irradiation with ultraviolet light is preferable. Examples of light sources used for the irradiation with ultraviolet light include mercury lamp, metal halide lamp, gallium lamp, mercury xenon lamp and flash lamp. Further, irradiation with sunlight is also effective. As the apparatus for the irradiation with ultraviolet light or the like, an apparatus of scanning type or non-scanning type is selected according to the irradiation area, irradiation dose, etc., and the irradiation conditions such as irradiation width are determined according to the irradiation energy required to decompose the dirt. Examples of the acid gases to be contacted include SO₂ gas and CO₂ gas.

When the antifouling film is formed on a surface of paper such as copying paper or a surface of an OHP sheet, the antifouling film can be also used as an ink-receiving layer that is used for printing by an ink jet printer or the like. In this case, the dirt substance having adhered to paper or the like can be decomposed by the irradiation with ultraviolet light or the contact with an acid gas or ozone, and besides, the ink taken into the ink-receiving layer as a printed letter or a printed image can be decomposed by the irradiation with ultraviolet light or the contact with an acid gas or ozone though it depends upon the type of the printing ink, and this contributes to recycling of papers. Further, by selecting the type of the printing ink or by controlling the conditions of the irradiation with ultraviolet light or the contact with an acid gas or ozone, color of the printed letter or the printed image can be made lighter.

When the antifouling film is applied to a ship's bottom or the like, adhesion of green algae such as ulva to the ship's bottom or the like can be inhibited without taking a special means.

It is presumed that in the antifouling film formed from the titanium-containing silica sol (a1s) of the invention comprising (a1) the titania fine particles having a mean particle diameter of 2 to 50 nm and the porous silica fine particles having a mean particle diameter of 5 to 100 nm and a specific surface area, as determined by BET method, of not less than 300 m²/g, and (b) the dispersion medium, the packing density of the titania fine particles and the porous silica fine particles after drying is high, and a larger amount of titania fine particles can be blended with the porous silica fine particles, so that when the silica sol is applied to the antifouling film, excellent antifouling effect is exerted.

Further, it is presumed that in the antifouling film formed from the titanium-containing silica sol (a2s) of the invention comprising (a2) the porous silica fine particles obtained by surface-modifying surfaces of porous silica fine particles having a mean particle diameter of 5 to 100 nm and a specific surface area, as determined by BET method, of not less than 300 m²/g with a titanate compound, and (b) the dispersion medium, titanate treatment proceeds to many pores of the porous silica fine particles or cavities at the centers of the particles, and therefore, the amount of titanate surface-modifying the porous silica fine particles is increased, so that when the silica sol is applied to the antifouling film, more excellent antifouling effect is exerted.

### Ink-receiving Layer-forming Coating Liquid and Process for Preparing the Same

The ink-receiving layer-forming coating liquid of the invention comprises the titanium-containing sol of the invention and a binder (c′).

In this specification, the dispersion medium (b) contained in the ink-receiving layer-forming coating liquid is also referred to as a “solvent (B) consisting of water and/or an organic solvent”.

The ink-receiving layer-forming coating liquid of the invention is preferably an ink-receiving layer-forming coating liquid wherein:
100 parts by weight of the fine particles (a) (that is, the titania fine particles and the porous silica fine particles (a1), or the porous silica fine particles (a2) obtained by surface modification with a titanate compound) and 5 to 7 parts by weight of the binder (c′) are contained,
the ratio between the weight (W_{B}) of the dispersion medium (b) (solvent (B) consisting of water and/or an organic solvent) and the total weight (W_{A}+W_{C′}) of the fine particles (a) and the binder (c′) (components (a) and (c′) being together also referred to as “solids content”), W_{B}:(W_{A}+W_{C′}), is 99.9 to 50:0.1 to 50 (total: 100), and
the content of Si and Ti constituting the fine particles (a) (that is, the fine particles (a1) or the fine particles (a2)) is in the range of 5 to 21,000 in terms of a SiO₂/TiO₂ weight ratio.

(c′) Binder

Examples of the binders (c′) employable in the ink-receiving layer-forming coating liquid of the invention include hydrophilic polymers, such as polyvinyl alcohol, modified polyvinyl alcohol, polyvinyl pyrrolidone and modified polyvinyl pyrrolidone.

Although the amount of the binder (c′) used varies depending upon the type of the binder, it is desirably in the range of 5 to 7 parts by weight based on 100 parts by weight of the fine particles (a) (that is, the fine particles (a1) or the fine particles (a2)). In the case where the fine particles (a1) and the fine particles (a2) are used in combination when needed, the amount of the binder (c′) is desirably the above-mentioned parts by weight based on the total 100 parts by weight of the fine particles (a1) and the fine particles (a2). If the amount of the binder (c′) is less than 5 parts by weight, adhesive force of the ink-receiving layer to the substrate such as a sheet is sometimes insufficient and peeling of the ink-receiving layer is liable to occur, and the strength of the ink-receiving layer sometimes becomes insufficient. If the amount of the binder (c′) exceeds 7 parts by weight, the amount of an ink received is sometimes decreased, and water resistance is sometimes lowered.

For the purpose of enhancing adhesion between the ink-receiving layer and the substrate such as a sheet, improving strength and weathering resistance of the ink-receiving layer or controlling pore structure of the ink-receiving layer, the ink-receiving layer-forming coating liquid of the invention may contain antioxidant, organic polymers such as celluloses, bio-fibers, inorganic polymers, inorganic fine particles, etc.

Process for Preparing Ink-receiving Layer-forming Coating Liquid

There is no specific limitation on the process for preparing the ink-receiving layer-forming coating liquid comprising the titania fine particles and the porous silica fine particles (a1) (fine particles (a1)), and the ink-receiving layer-forming coating liquid can be prepared by mixing the fine particles (a1), the binder (c′) and the solvent (B) consisting of water and/or an organic solvent with one another. From the viewpoint of practical use, preferable is a preparation process comprising mixing the titanium-containing silica sol (a1s) wherein the fine particles (a1) are dispersed in the dispersion medium (b), the binder (c′) and the solvent (B) consisting of water and/or an organic solvent with one another.

Further, there is no specific limitation on the process for preparing the ink-receiving layer-forming coating liquid comprising the porous silica fine particles (a2) obtained by surface modification with a titanate compound (fine particles (a2)), and the ink-receiving layer-forming coating liquid can be prepared by mixing the fine particles (a2), the binder (c′) and the solvent (B) consisting of water and/or an organic solvent with one another. From the viewpoint of practical use, however, preferable is a preparation process comprising mixing the titanium-containing silica sol (a2s) wherein the fine particles (a2) are dispersed in the dispersion medium (b), the binder (c′) and the solvent (B) consisting of water and/or an organic solvent with one another.

In the case where a sufficient amount, in order to secure fluidity of an ink-receiving layer-forming coating liquid, of the dispersion medium (b) is contained in the titanium-containing silica sol (a1s) or the titanium-containing silica sol (a2s) it is unnecessary to further add the solvent (B) consisting of water and/or an organic solvent.

For mixing the above components, an apparatus, such as homogenizer, homomixer, roller type dispersing machine, three-roll mill, intensive stirring machine, ultrasonic wave or sand mill, is employed.

### Recording Substrate with Ink-receiving Layer

The recording substrate with an ink-receiving layer of the invention comprises a substrate and an ink-receiving layer formed on a surface of the substrate. The recording substrate with an ink-receiving layer is preferably a recording sheet with an ink-receiving layer, which comprises a substrate in the form of a sheet (also referred to as a “substrate sheet” hereinafter) and an ink-receiving layer formed on a surface of the substrate.

Although the substrate sheet is not specifically restricted, usually used are resin film sheets such as those of PET or vinyl chloride, plain paper, various papers, steel plate, cloths, etc. These substrates may be used after subjecting them to primer treatment.

The titania fine particles and the porous silica fine particles (a1) or the surface-modified porous silica fine particles (a2) may be primary particles, secondary particles or a mixture of primary particles and secondary particles. The secondary particles mean aggregates of primary particles, which do not easily become monodispersed primary particles in the coating liquid. The primary particles may contain primary particle-like particles formed by disintegration of secondary particles.

For forming the ink-receiving layer on the substrate, publicly known processes are adoptable, and a preferred process is selected according to the type of the substrate.

More specifically, the recording substrate with an ink-receiving layer can be formed by coating a substrate surface with the aforesaid ink-receiving layer-forming coating liquid by spraying, roll coater method, blade coater method, bar coater method, curtain coater method or the like and then drying the coating layer.

Further, the recording substrate with an ink-receiving layer can be formed also by coating a substrate surface with the ink-receiving layer-forming coating liquid in which the fine particles (a1) or the fine particles (a2) are dispersed in water and/or an organic solvent, drying the coating layer and then allowing the surfaces of the fine particles (a1) or the fine particles (a2) to support a cationic hydrated metal compound. For example, a substrate such as a sheet is coated with a solution of the cationic hydrated metal compound that optionally contains an alkali, by spraying, roll coater method, blade coater method, bar coater method, curtain coater method or the like and then the coating layer is dried, whereby the cationic hydrated metal compound can be supported on the surfaces of the fine particles (a1) or the fine particles (a2).

The cationic hydrated metal compound is, for example, Al₂(OH)₅Cl or ZrOCl₂. The cationic hydrated metal compound is supported in such an amount that the weight ratio of the cationic hydrated metal compound to the oxide particles (cationic hydrated metal compound/fine particles (a1) or fine particles (a2)) is in the range of 0.005 to 0.2. The concentration of the solution of the cationic hydrated metal compound is not specifically restricted provided that the ratio of the cationic hydrated metal compound to the fine particles (a1) or the fine particles (a2) is in the above range.

The coating and the drying can be carried out repeatedly.

In general, the ink-receiving layer formed as above preferably has at least pores having pore diameters of 3.4 to 2,000 nm in any of a case of using a dye-based ink and a case of using a pigment ink. Further, it is preferable that the pore volume of pores having pore diameters of 3.4 to 30 nm of the above pores is in the range of 0.2 to 3.0 ml/g or the pore volume of pores having pore diameters of 30 to 2,000 nm of the above pores is in the range of 0.1 to 2.5 ml/g.

If the pore volume of pores having pore diameters of 3.4 to 30 nm is less than 0.2 ml/g, ink absorption volume is small, and ink blotting occurs, so that an image of sharpness and high accuracy cannot be obtained occasionally. If the pore volume of pores having pore diameters of 3.4 to 30 nm is more than 3.0 ml/g, fixing property of a dye is sometimes lowered, and the strength of the ink-receiving layer is sometimes lowered.

If the pore volume of pores having pore diameters of 30 to 2,000 nm is less than 2.5 ml/g, a pigment ink cannot be absorbed sufficiently, so that pigment particles remain on the surface of the receiving layer, and they sometimes peel off by abrasion to cause fading of the recording substrate with an ink-receiving layer. If the pore volume of pores having pore diameters of 30 to 2,000 nm is more than 2.5 ml/g, fixing property of pigment particles is sometimes lowered, or after printing, most of pigment particles stay on the lower part of the ink-receiving layer (in the vicinity of substrate surface), and a letter or an image printed on the recording substrate with an ink-receiving layer sometimes lacks sharpness.

Although the thickness of the ink-receiving layer formed on the substrate can be arbitrarily determined according to the thickness of the substrate, purpose of the printed matter, type of the printing ink, etc., it is desirably in the range of usually 0.5 to 100 μm. If the thickness of the ink-receiving layer is less than 0.5 μm, ink absorption volume is sometimes insufficient, and ink blotting sometimes occurs. If the amount of the ink used is decreased, color is sometimes lowered. It is difficult to obtain an ink-receiving layer having a thickness of more than 100 μm by one coating operation, and coating operations of plural times become a problem from the viewpoint of economical efficiency, and besides, cracking or peeling sometimes takes place when the resulting layer is dried after coating operations. Moreover, decoloring property is sometimes deteriorated.

The pore volume based on unit weight of the ink-receiving layer is a value measured by the following mercury penetration method.
(1) In a measuring cell (volume: 0.5 cc), about 0.2 to 0.3 g of a recording sheet with an ink-receiving layer, a weight ratio of whose sheet to whose ink-receiving layer has been determined in advance, is placed, and a pore distribution is measured by AUTOSCAN-60 PORPSIMETER manufactured by QUANTA CHROME under the conditions of a mercury contact angle of 130°, a mercury surface tension of 473 dyn/cm² and a measuring range of “high pressure”.
(2) Subsequently, from the pore distribution thus measured, a pore volume of pores having pore diameters of 3.4 to 30 nm and a pore volume of pores having pore diameters of 30 to 2,000 nm are determined, and from the measured weight of the receiving layer of the recording sheet, a pore volume based on 1 g of the receiving layer is determined.

Decoloring Method

After a printed letter or a printed image is formed on the recording substrate with an ink-receiving layer of the invention by means of ink jet printing or the like, the printed letter or the printed image is irradiated with ultraviolet light or brought into contact with an acid gas or ozone, whereby the printed letter or the printed image can be decolored.

Of the above means, irradiation with ultraviolet light is preferable. Examples of light sources used for the irradiation with ultraviolet light include mercury lamp, metal halide lamp, gallium lamp, mercury xenon lamp and flash lamp. Further, irradiation with sunlight is also effective. As the apparatus for the irradiation with ultraviolet light or the like, an apparatus of scanning type or non-scanning type is selected according to the irradiation area, irradiation dose, etc., and the irradiation conditions such as irradiation width are determined according to the irradiation energy required to decompose the printed letter or the printed image. Examples of the acid gases to be contacted include SO₂ gas and CO₂ gas.

The degree of decoloring effect can be properly controlled also by the time of using the decoloring means (irradiation with ultraviolet light or contact with acid gas or ozone).

The ink used for forming the printed letter or the printed image is not specifically restricted provided that the decoloring effect is obtained by the above decoloring means, and any of an ink containing a dye and an ink containing a pigment is employable.

Preferred examples of the inks containing dye include inks containing basic dyes, such as C.I. Solvent Black 27, C.I. Solvent Black 28, C.I. Solvent Black 22, C.I. Solvent Black 29, C.I. Solvent Red 83-1, C.I. Solvent Red 125, C.I. Solvent Red 132, C.I. Solvent Blue 47, C.I. Solvent Blue 48, C.I. Solvent Blue 70, C.I. Solvent Yellow 88, C.I. Solvent Yellow 89, C.I. Basic Violet 1, C.I. Basic Violet 3, C.I. Basic Red 1, C.I. Basic Red 8, C.I. Basic Black 2, Basic Blue 5, Basic Blue 7, Basic Violet 1, Basic Violet 10, Basic Orange 22, Basic Red 1:1, Basic Yellow 1, Basic Yellow 2 and Basic Yellow 3.

In addition, natural dyes produced by microorganism and exhibiting decoloring property by the use of ultraviolet light are also employable. Examples of such natural dyes include Beni-Koji dye (monascus color).

Examples of solvents for the above dyes include ketones, such as methyl ethyl ketone, acetone and cyclohexane; alcohols, such as methanol, ethanol and isopropanol; ethers, such as cellosolve and butyl cellosolve; alkylene glycols, such as ethylene glycol, diethylene glycol, triethylene glycol, propylene glycol, and hexylene glycol; alkyl ethers of polyhydric alcohols, such as ethylene glycol methyl ether, diethylene glycol methyl ether, triethylene glycol monomethyl ether, diethylene glycol ethyl ether and triethylene glycol monoethyl ether; polyalkylene glycols, such as glycerol, plyethylene glycol and polypropylene glycol; nitrogen-containing heterocyclic ketones, such as N-methyl-2-pyrrolidone and 1,3-dimethyl-2-imidazolidinone; and ion-exchanged water. These solvents can be used singly or as a mixture of two or more kinds.

As the ink that contains a pigment, an ink obtained by dispersing a pigment in an aqueous medium using a dispersant is employed. As the dispersant, a surface active agent or the like is widely employed. As the pigment, an organic pigment or an inorganic pigment is employable.

Examples of the organic pigments include azo pigments, such as azo lake, insoluble azo pigment, condensed azo pigment and chelate azo pigment; polycyclic pigments, such as phthalocyanine pigment, perylene pigment, perynone pigment, anthraquinone pigment, quinacridone pigment, dioxazine pigment, thioindigo pigment, isoindolinone pigment and quinophthalone pigment; dye chelate, such as basic dye type chelate and acid dye type chelate; nitro pigment; nitroso pigment; and aniline black.

Examples of the inorganic pigments include titanium oxide, iron oxide, and carbon black produced by a publicly known process, such as contact process, furnace process or thermal process, specifically, carbon black (C.I. Pigment Black 7), such as furnace black, lamp black, acetylene black or channel black.

### EXAMPLES

The present invention is further described with reference to the following examples, but it should be construed that the invention is in no way limited to those examples.

### Evaluation Method

Specific Surface Area

The specific surface area of silica fine particles was measured in the following manner. A silica sol was dried by a freeze dryer and then dried at 110° C. for 20 hours to prepare a sample, and the specific surface area of the sample was measured by a nitrogen adsorption method (BET method) using a specific surface area measuring device (manufactured by Yuasa Ionics Inc., “Multisorb 12”).

### Mean Particle Diameter

The mean particle diameter of silica fine particles was measured by a dynamic light scattering method using a particle size distribution measuring device (manufactured by Particle Sizing Systems, “NICOMP MODEL 380”).

Surface Electric Charge

The surface electric charge of silica fine particles is measured in the following manner. A pure water dispersion of silica-alumina modified fine particles having a concentration of 1% by weight in terms of oxide (SiO₂+MOₓ) was prepared, then the dispersion was poured into a measuring container, and the surface electric charge was measured by a flow potential measuring machine (MUTEK, PCD02) using a polymer having an opposite electric charge to the particle electric charge. Silica fine particles having negative electric charge were titrated using 0.001N pdly-DADMAC (cationic high-molecular electrolyte) as a polymer standard solution.

### Compositional Analysis

The contents of Ti, Al, Na and Si were measured in the following manner.

(1) Ti Content and Al Content (in Terms of TiO₂ Content and Al₂O₃ Content)

Pretreatment described below was carried out, and then the contents were measured by the use of an ICP light emission analysis device (Seiko Instruments Inc., SPS 1200A).

About 5 g of a titanate-containing silica sol is withdrawn into a platinum dish.

2. The sol is evaporated to dryness on a sand bath and calcined for about 1 minute in an electric oven at 1000° C.

3. 2 ml of sulfuric acid (1+1) and 10 ml of hydrofluoric acid are added, then the mixture is heated until white smoke of sulfuric acid is generated on the sand bath, and thereafter the resulting product is diluted with distilled water to give 100 ml of a dilute solution.

(2) Na Content (in Terms of Na₂O Content)

The same pretreatment as in the above (1) was carried out, and then the Na content was measured by the use of an atomic absorption spectrometer (Hitachi Z-5300).

(3) Si Content (in Terms of SiO₂ Content)

A titanate-containing silica sol was heated at 1000° C. for 1 hour, and the weight (solids content weight) was measured. Then, the total content of TiO₂, Al₂O₃ and Na₂O was determined in the same manner as in the above (1) and (2), and the resulting value was subtracted from the weight of the whole solids content to determine the content of SiO₂.

### Preparation of Porous Silica Fine Particles

Preparation of Silica Sol

3.51 kg of a spherical silica sol Al (silica mean particle diameter: 30 nm, solvent: water, solids concentration: 19.9% by weight) was diluted with 12.0 kg of pure water, and the dilute sol was stirred for 10 minutes to prepare an aqueous silica sol having a solids concentration of 4.5% by weight. To the aqueous silica sol was added 318 g of water glass to adjust pH to 11, and the resulting aqueous silica sol was heated to 98° C., followed by holding it at 98° C. for 15 minutes.

### Addition of Dilute Silicic Acid Solution

A sodium silicate aqueous solution (SiO₂ concentration: 4.9% by weight) was passed through a cation-exchange resin to perform cation exchange, whereby 11.0 kg of a silicic acid solution having a SiO₂ concentration of 4.8% by weight was obtained. To the silicic acid solution was added 6.52 kg of pure water to prepare a dilute silicic acid solution having a SiO₂ concentration of 3.0% by weight. Then, 17.5 kg of the dilute silicic acid solution was added to the aqueous silica sol at 98° C. over a period of 6 hours, and the resulting mixture was held at 98° C. for 1 hour. Subsequently, the mixture was cooled down to not higher than 40° C. to obtain 26.8 kg of a silica sol having a solids concentration of 4.8% by weight, a conductivity at 38.9° C. of 1.819 mS/cm and pH at 31.8° C. of 10.53.

### Dealuminum Treatment

To 10.0 kg of the silica sol obtained in the previous step, 613 g of 35% hydrochloric acid was added over a period within 1 minute, and they were stirred for 10 minutes to leach aluminum ion from the silica fine particles, whereby a leaching product was obtained. Then, the leaching product was subjected to primary concentration using an ultrafiltration membrane (Asahi Kasei Corp., SIP-1013) until the solids concentration of the leaching product became twice. The concentrated silica sol was washed, by the use of an ultrafiltration membrane similarly to the above with mainlining the liquid level constant, with dilute hydrochloric acid of pH 3.0 over a period of 5 hours and then the silica sol was further washed with pure water until pH of the mother liquor became 3.0, to obtain a pure water washed product.

Then, secondary concentration was carried out to concentrate the pure water washed product until the solids concentration of the pure water washed product became twice. The specific surface area of silica in the resulting silica sol (referred to as a “silica sol B1” hereinafter) and the contents of Si, Al and Na (in terms of the corresponding oxide) in the silica sol B1 measured in the same manner as in the aforesaid compositional analysis are set forth in

TABLE 1-1

| | Mean | Specific | | | |
|---|---|---|---|---|---|
| | Particle | surface | | | |
| | diameter | area | SiO₂ | Al₂O₃ | Na₂O |
| | (nm) | (m²/g) | (wt %) | (wt %) | (wt %) |
| Silica | 30 | 451 | 12.7 | 0.1 | 0.01 |
| sol B1 | | | | | |
| Spherical | 30 | 92 | 14.8 | 5.1 | 3.57 |
| silica | | | | | |
| sol A1 | | | | | |

TABLE 1-2

| | Mean Particle | Specific surface |
|---|---|---|
| | diameter | area |
| | (nm) | (m²/g) |
| Spherical silica sol | 1 | 700 |
| A2 | | |

TABLE 1-3

| | Mean | Specific | | | |
|---|---|---|---|---|---|
| | Particle | surface | | | |
| | diameter | area | Si0₂ | Al₂O₃ | NaO |
| | (nm) | (m²/g) | (wt %) | (wt %) | (wt %) |
| Silica | 25 | 523 | 12.0 | 0.1 | 0.01 |
| sol B3 | | | | | |
| Spherical | 25 | 250 | 15.0 | 4.7 | 2.73 |
| silica | | | | | |
| sol A3 | | | | | |

TABLE 1-4

| | Mean | Specific | | | |
|---|---|---|---|---|---|
| | Particle | surface | | | |
| | diameter | area | SiO₂ | Al₂O₃ | Na₂O |
| | (nm) | (m²/g) | (wt %) | (wt %) | (wt %) |
| Silica | 80 | 600 | 12.1 | 0.2 | 0.02 |
| sol B4 | | | | | |
| Spherical | 80 | 120 | 14.5 | 4.5 | 2.53 |
| silica | | | | | |
| sol A4 | | | | | |

TABLE 1-5

| | Mean | Specific | | | |
|---|---|---|---|---|---|
| | Particle | surface | | | |
| | diameter | area | SiO₂ | A1₂O₃ | Na₂O |
| | (nm) | (m²/g) | (wt %) | (wt %) | (wt %) |
| Silica | 120 | 400 | 12.0 | 0.4 | 0.03 |
| sol B5 | | | | | |
| Spherical | 120 | 23 | 15.3 | 5.2 | 2.84 |
| silica | | | | | |
| sol A5 | | | | | |

In the above preparation process of the porous silica fine particles, a mean particle diameter of a spherical silica sol (raw material), composition of the silica sol and conditions of the dealuminum treatment were appropriately set with making reference to the description of Japanese Patent Laid-Open Publication No. 233611/2001, that is, spherical silica sols having mean particle diameters of 25 nm, 80 nm and 120 nm were each used as a raw material and other conditions were determined in accordance with the aforesaid conditions, whereby various silica sols (25 nm, 80 nm and 120 nm) each having a solids concentration of 12% by weight and using isopropyl alcohol as a dispersion medium were prepared. Properties of silica fine particles in the silica sols are as shown in Table 1-3 to Table 1-5, Table 2 and Table 3. The spherical silica sol A2 (Table 1-2) having a mean particle diameter of 1 nm was subjected to the following experiments without carrying out the process for the preparation of porous silica fine particles.

Preparation of Titania-containing Silica Sol Comprising Titania Fine Particles, Porous Silica Fine Particles and Dispersion Medium

### Examples 1-1 to 1-7, Comparative Examples 1-1 to 1-6

To 300 g of each silica sol shown in Table 2, a titania sol (solids concentration: 10% by weight, titania mean particle diameter: 10 nm, dispersion medium: isopropyl alcohol, crystal form: anatase type) was added so that the weight ratio of Si to Ti (in terms of SiO₂/TiO₂) should become that shown in Table 2, and they were stirred and mixed to prepare a titanium-containing silica sol.

Preparation of Titania-containing Silica Sol Comprising Porous Silica Fine Particles Modified with Titanate Compound and Dispersion Medium

### Examples 2-1 to 2-7, Comparative Examples 2-1 to 2-6

To 300 g of each silica sol shown in Table 3, a titanate compound (Prenact (trademark) KR-44, Ajinomoto Co., Inc., compound name: isopropyl tri(N-aminoethyl-aminoethyl)titanate) was added over a period of 1 minute at ordinary temperature, and thereafter they were stirred and mixed over a period of 2 hours at ordinary temperature to obtain a titanium-containing silica sol. The weight of the titanate compound added to each silica sol and the weight ratio of Si to Ti (in terms of SiO₂/TiO₂) in the resulting titanium-containing silica sol are set forth in Table 3.

### Example 3-1

A titanium-containing silica sol was obtained in the same manner as in Example 2-3, except that tetraisopropoxytitanate was used instead of the titanate compound (Prenact (trademark) KR-44). The weight of the titanate compound added to the silica sol and the weight ratio of Si to Ti (in terms of SiO₂/TiO₂) in the resulting titanium-containing silica sol are set forth in Table 3.

Preparation of Antifouling Film-forming Composition

100 g of the titanium-containing silica sol prepared in Example 1-1 and a cellulose binder (ethyl cellulose aqueous solution, solids concentration: 5% by weight) were mixed so that the solids content weight ratio between the titanium-containing silica sol and the cellulose binder should become 75:25 (titanium-containing silica sol:cellulose binder), to prepare an antifouling film-forming composition.

Using the titanium-containing silica sols prepared in Examples 1-2 to 1-7, Comparative Examples 1-1 to 1-6, Examples 2-1 to 2-7, Comparative Examples 2-1 to 2-6, and Example 3-1, antifouling film-forming compositions were prepared in the same manner as in the above process using the titanium-containing silica sol prepared in Example 1-1.

Test for Prevention of Adhesion of Aquatic Life

In each of the antifouling film-forming composition containing the titanium-containing silica sol prepared in Example 1-1 and the antifouling film-forming composition containing the titanium-containing silica sol prepared in Example 2-1, a polyethylene net material was immersed for 10 minutes to coat the net material with the composition, and the net material was subjected to air drying. The coating weights of the compositions were each 1 part by weight based on 100 parts by weight of the net material after drying. These net materials and a net material coated with no antifouling film-forming composition were immersed in a constant temperature water bath (30° C.), allowed to stand for 3 months in the environment where the net materials were exposed to natural light and then pulled up from the water bath. The two net materials coated with the antifouling film-forming composition were remarkably prevented from growth of sphagnum moss as compared with the net material coated with no antifouling film-forming composition.

Dirt Decomposition Test

One surface of plain paper was coated with the antifouling film-forming composition prepared above in a coating weight of 5 g/m² and dried at 80° C. to prepare plain paper with an ink-receiving layer having an antifouling film. In this preparation, one sheet of plain paper was coated with one kind of an antifouling film-forming composition.

The plain paper with an ink-receiving layer having an antifouling film was set in a dirt chamber test machine (internal volume: 60 liters) and then smoked with 3 cigarettes (content of nicotine and tar: 16 mg/one cigarette) for 3 minutes to deposit smoke particles on the paper surface and thereby make the paper surface dirty. The thus treated paper surface was irradiated with ultraviolet light by means of a high-pressure mercury lamp in a mini-conveyer type UV irradiation apparatus (manufactured by Nippon Denchi K.K.), and the time required for decomposition of the dirt was measured. The results are set forth in Table 2 and Table 3.

Further, the dirt chamber test machine was filled with an ozone gas, then the paper to which the smoke particles had adhered to make the paper dirty was placed in the machine, and the time required for decomposition of the dirt was measured. The results are set forth in Table 2 and Table 3.

The time required for decomposition of the dirt was measured in the following manner. The color of the plain paper to the surface of which the smoke particles had adhered to make the surface dirty and the color (white) of plain paper with an ink-receiving layer prepared as a reference using each antifouling film-forming composition were compared through visual observation, and a period of time required for that these colors became the same as each other was regarded as the time required for decomposition of dirt.

TABLE 2
(Titanium-containing silica sol comprising titania fine particles
and porous silica fine particles, and isopropyl alcohol)

| | | Silica sol | | | | | | |
|---|---|---|---|---|---|---|---|---|
| | | | Mean | Specific | Surface | | | |
| | | | particle | surface area | electric | Al | | Titanium- |
| | | | diameter of | of silica | charge of | concentration* | | containing |
| | | Solids | silica fine | fine | silica fine | in silica fine | Titania sol | silica sol |
| | Sample | concentration | particles | particles | particles | particles | Weight | SiO₂/TiO₂ |
| zebra | No. | (wt %) | (nm) | (m²/g) | (μeq/g) | (wt %) | (g) | weight ratio |
| Comp. | A | 12 | 1 | 700 | 70 | 0.2 | 0.060 | 6000 |
| Ex. 1-1 | | | | | | | | |
| Ex. 1-1 | B | 12 | 25 | 523 | 52 | 0.9 | 0.057 | 6276 |
| Ex. 1-2 | C | 12 | 80 | 600 | 60 | 0.9 | 0.063 | 5688 |
| Comp. | D | 12 | 120 | 400 | 40 | 0.9 | 0.055 | 6472 |
| Ex. 1-2 | | | | | | | | |
| Comp. | E | 12 | 1 | 700 | 70 | 0.2 | 0.060 | 6000 |
| Ex. 1-3 | | | | | | | | |
| Ex. 1-3 | F | 12 | 25 | 523 | 52 | 0.9 | 0.057 | 6276 |
| Ex. 1-4 | G | 12 | 80 | 600 | 60 | 0.9 | 0.063 | 5688 |
| Comp. | H | 12 | 120 | 400 | 40 | 0.9 | 0.055 | 6472 |
| Ex. 1-4 | | | | | | | | |
| Comp. | I | 12 | 80 | 600 | 58 | 1 | 360 | 1 |
| Ex. 1-5 | | | | | | | | |
| Ex. 1-5 | J | 12 | 80 | 600 | 60 | 1.1 | 0.443 | 813 |
| Ex. 1-6 | K | 12 | 80 | 600 | 62 | 0.9 | 0.057 | 6276 |
| Ex. 1-7 | L | 12 | 80 | 600 | 55 | 1 | 0.018 | 20000 |
| Comp. | M | 12 | 80 | 600 | 60 | 1.1 | 0.012 | 30000 |
| Ex. 1-6 | | | | | | | | |

| | | Dirt decomposition test | | Decoloring test | |
|---|---|---|---|---|---|
| | | Irradiation with | | Irradiation with | |
| | | ultraviolet light (light | | ultraviolet light (light | |
| | | intensity: 600 mJ/cm²) | Contact with ozone | intensity: 600 mJ/cm²) | Contact with ozone |
| | | Time required for dirt | Time required for dirt | Time required for | Time required for |
| | Sample | decomposition | decomposition | decoloring | decoloring |
| zebra | No. | (sec) | (sec) | (sec) | (sec) |
| Comp. | A | 100 | — | 16 | — |
| Ex. 1-1 | | | | | |
| Ex. 1-1 | B | 10 | — | 8 | — |
| Ex. 1-2 | C | 12 | — | 6 | — |
| Comp. | D | 50 | — | 35 | — |
| Ex. 1-2 | | | | | |
| Comp. | E | — | 70 | — | 48 |
| Ex. 1-3 | | | | | |
| Ex. 1-3 | F | — | 10 | — | 10 |
| Ex. 1-4 | G | — | 12 | — | 12 |
| Comp. | H | — | 50 | — | 43 |
| Ex. 1-4 | | | | | |
| Comp. | I | 110 | — | 2 (appearance: turbid) | — |
| Ex. 1-5 | | | | | |
| Ex. 1-5 | J | 16 | — | 5 | — |
| Ex. 1-6 | K | 12 | — | 8 | — |
| Ex. 1-7 | L | 21 | — | 11 | — |
| Comp. | M | 90 | — | 49 | — |
| Ex. 1-6 | | | | | |

*Al concentration is a value in terms of Al₂O₃ determined by the following formula.
Al concentration = weight of Al₂O₃/(weight of Al₂O₃ + weight of SiO₂) × 100

TABLE 3
(Titanium-containing silica sol comprising porous silica fine particles
surface-modified with titanate compound and isopropyl alcohol)

| | | Silica sol | | | | | | |
|---|---|---|---|---|---|---|---|---|
| | | | Mean | Specific | Surface | | | |
| | | | particle | surface area | electric | Al | | Titanium- |
| | | | diameter of | of silica | charge of | concentration* | Titanate | containing |
| | | Solids | silica fine | fine | silica fine | in silica fine | compound | silica sol |
| | Sample | concentration | particles | particles | particles | particles | Weight | SiO₂/TiO₂ |
| zebra | No. | (wt %) | (nm) | (m²/g) | (μeq/g) | (wt %) | (g) | weight ratio |
| Comp. | a | 12 | 1 | 700 | 70 | 0.2 | 0.031 | 6050 |
| Ex. 2-1 | | | | | | | | |
| Ex. 2-1 | b | 12 | 25 | 523 | 52 | 0.9 | 0.030 | 6245 |
| Ex. 2-2 | c | 12 | 80 | 600 | 60 | 0.9 | 0.033 | 5660 |
| Comp. | d | 12 | 120 | 400 | 40 | 0.9 | 0.029 | 6440 |
| Ex. 2-2 | | | | | | | | |
| Comp. | e | 12 | 1 | 700 | 70 | 0.2 | 0.031 | 6050 |
| Ex. 2-3 | | | | | | | | |
| Ex. 2-3 | f | 12 | 25 | 523 | 52 | 0.9 | 0.030 | 6245 |
| Ex. 2-4 | g | 12 | 80 | 600 | 60 | 0.9 | 0.033 | 5660 |
| Comp. | h | 12 | 120 | 400 | 40 | 0.9 | 0.029 | 6440 |
| Ex. 2-4 | | | | | | | | |
| Comp. | i | 12 | 80 | 600 | 58 | 1 | 187.7 | 1 |
| Ex. 2-5 | | | | | | | | |
| Ex. 2-5 | j | 12 | 80 | 600 | 60 | 1.1 | 0.231 | 813 |
| Ex. 2-6 | k | 12 | 80 | 600 | 62 | 0.9 | 0.030 | 6276 |
| Ex. 2-7 | l | 12 | 80 | 600 | 55 | 1 | 9.23 × 10⁻³ | 20325 |
| Comp. | m | 12 | 80 | 600 | 60 | 1.1 | 6.60 × 10⁻³ | 28455 |
| Ex. 2-6 | | | | | | | | |
| Ex. 3-1 | n | 12 | 25 | 523 | 52 | 0.9 | 0.021 | 6050 |

| | | Dirt decomposition test | | Decoloring test | |
|---|---|---|---|---|---|
| | | Irradiation with | | Irradiation with | |
| | | ultraviolet light (light | | ultraviolet light (light | |
| | | intensity: 600 mJ/cm²) | Contact with ozone | intensity: 600 mJ/cm²) | Contact with ozone |
| | | Time required for dirt | Time required for dirt | Time required for | Time required for |
| | Sample | decomposition | decomposition | decoloring | decoloring |
| zebra | No. | (sec) | (sec) | (sec) | (sec) |
| Comp. | a | 70 | — | 53 | — |
| Ex. 2-1 | | | | | |
| Ex. 2-1 | b | 14 | — | 9 | — |
| Ex. 2-2 | c | 16 | — | 10 | — |
| Comp. | d | 80 | — | 51 | — |
| Ex. 2-2 | | | | | |
| Comp. | e | — | 50 | — | 48 |
| Ex. 2-3 | | | | | |
| Ex. 2-3 | f | — | 6 | — | 5 |
| Ex. 2-4 | g | — | 8 | — | 7 |
| Comp. | h | — | 50 | — | 39 |
| Ex. 2-4 | | | | | |
| Comp. | i | 70 | — | 38 | — |
| Ex. 2-5 | | | | | |
| Ex. 2-5 | j | 12 | — | 7 | — |
| Ex. 2-6 | k | 16 | — | 10 | — |
| Ex. 2-7 | l | 20 | — | 6 | — |
| Comp. | m | 80 | — | 63 | — |
| Ex. 2-6 | | | | | |
| Ex. 3-1 | n | 12 | — | 12 | — |

*Al concentration is a value in terms of Al₂O₃ determined by the following formula.
Al concentration = weight of Al₂O₃/(weight of Al₂O₃ + weight of SiO₂) × 100

Preparation of Ink-receiving Layer-forming Coating Liquid

100 g of the titanium-containing silica sol prepared in Example 1-1 and a cellulose binder (ethyl cellulose aqueous solution, solids concentration: 5% by weight) were mixed so that the solids content weight ratio (titanium-containing silica sol:cellulose binder) should become 75:25, to prepare an ink-receiving layer-forming coating liquid.

Using the titanium-containing silica sols prepared in Examples 1-2 to 1-7, Comparative Examples 1-1 to 1-6, Examples 2-1 to 2-7, Comparative Examples 2-1 to 2-6, and Example 3-1, ink-receiving layer-forming coating liquids were prepared in the same manner as in the above process using the titanium-containing silica sol prepared in Example 1-1.

One surface of plain paper was coated with the ink-receiving layer-forming coating liquid prepared above in a coating weight of 5 g/m² and dried at 80° C. to prepare plain paper with an ink-receiving layer. In this preparation, one sheet of plain paper was coated with one kind of an ink-receiving layer-forming coating liquid.

Printing

On the resulting plain paper with an ink-receiving layer, a pattern W (letter “W” having a size with which 2 cm square is filled up and which has a thickness of about 3 mm) of black color was printed by means of an ink jet printer (manufactured by GRAPHTEC, Masterjet) using a genuine pigment ink and a genuine dye ink.

Decoloring Treatment

The surface of the printed plain paper with an ink-receiving layer was irradiated with ultraviolet light by means of a high-pressure mercury lamp in a mini-conveyer type UV irradiation apparatus (manufactured by Nippon Denchi K.K.), and the time required for decoloring of the pattern W was measured. The results are set forth in Table 2 and Table 3.

Further, a dirt chamber test machine was filled with an ozone gas, then the printed plain paper with an ink-receiving layer were placed in the dirt chamber test machine, and the time required for decoloring of the pattern W was measured. The results are set forth in Table 2 and Table 3.

The time required for decoloring was measured in the following manner. The color of the pattern W on the plain paper, on which printing had been made and then which had been subjected to ultraviolet light irradiation or the like to decolor the pattern W, and the color (white) of plain paper with an ink-receiving layer prepared as a reference using each antifouling film-forming composition were compared through visual observation, and a period of time required for that these colors became the same as each other was regarded as the time required for decoloring.

### INDUSTRIAL APPLICABILITY

By using the titanium-containing silica sol of the invention, an antifouling film exhibiting excellent antifouling performance can be formed on surfaces of various substrates, and further, an ink-receiving layer having excellent decoloring property can be formed. Accordingly, the titanium-containing silica sol of the invention can be utilized as a top coat of a ship's bottom paint, a fishing net paint, or a raw material of a surface treatment agent for wall materials, ceiling materials, floor materials, papers, etc.

1. A titanium-containing silica sol comprising:
(a) the following fine particles (a1) or the following fine particles (a2):
(a1) titania fine particles having a mean particle diameter of 2 to 50 nm and porous silica fine particles having a mean particle diameter of 5 to 100 nm and a specific surface area, as determined by BET method, of not less than 300 m²/g,
(a2) porous silica fine particles obtained by surface-modifying surfaces of porous silica fine particles having a mean particle diameter of 5 to 100 nm and a specific surface area, as determined by BET method, of not less than 300 m²/g, with a titanate compound, and
(b) a dispersion medium.

2. The titanium-containing silica sol as claimed in claim 1, wherein the titanate compound is represented by any one of the following formulas (1) to (3):
R¹¹ₙTiR¹²₄₋ₙ (1)
wherein n is an integer of 1 to 4;
R¹¹ is an alkoxy group having 1 to 6 carbon atoms, and when n is 2 or 3, two R¹¹ may be bonded to each other to form a ring structure represented by the following formula (1a), and further, two hydrogen atoms bonded to one carbon atom adjacent to an oxygen atom in the formula (1a) may be replaced with an oxygen atom to form a ring structure represented by the following formula (1b); and
R¹² is a hydrocarbon group having 1 to 5 carbon atoms or an organic group represented by the following formula (1c), (1d), (1e), (1f), (1g) or (1h): 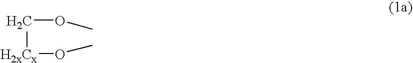
wherein x is an integer of 1 to 7, 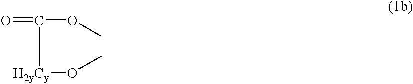
wherein y is an integer of 1 to 7, 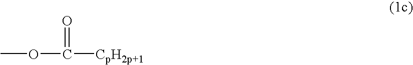
wherein p is an integer of 4 to 30, 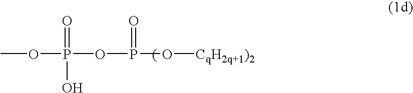
wherein q is an integer of 4 to 30, 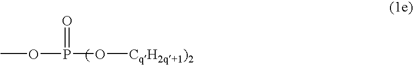
wherein q′ is an integer of 4 to 30,
—OCᵣH₂ᵣNHC_{r′}H_{2r′}NH₂ (1f)
wherein r and r′ are each an integer of 1 or greater, and r+r′ is 4 to 30, 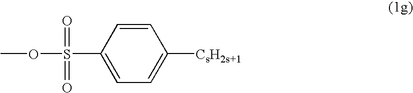
wherein s is an integer of 1 to 30, 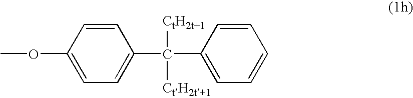
wherein t and t′ are each an integer of 1 to 30,
R²¹TiR²²R²³₂ (2)
wherein R²¹ is an alkoxy group having 1 to 4 carbon atoms, R²² is an organic group represented by the following formula (2a), and R²³ is an organic group represented by the following formula (2b): 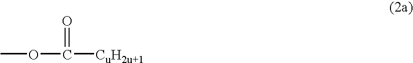
wherein u is an integer of 4 to 30, 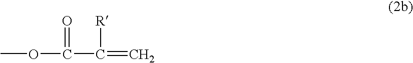
wherein R′ is a hydrogen atom or an alkyl group having 1 to 4 carbon atoms,
R³¹₄Ti.[P(OC_{2w}H_{2w+1})₂(OH)]₂ (3)
wherein R³¹ is an alkoxy group having 1 to 20 carbon atoms;
a part of hydrogen atoms in the alkoxy group may be replaced with an organic group having 4 to 12 carbon atoms and having at least one of an ether linkage and a double bond; and
w is an integer of 4 to 20.

3. The titanium-containing silica sol as claimed in claim 1, wherein the content of Si and Ti constituting the titania fine particles and the porous silica fine particles (a1) or the porous silica particles (a2) obtained by surface modification with the titanate compound is in the range of 5 to 21,000 in terms of a SiO₂/TiO₂ weight ratio.

4. The titanium-containing silica sol as claimed in claim 1, wherein the surface electric charge of the porous silica fine particles is in the range of 10 to 150 μeq based on 1 g of the fine particles.

5. The titanium-containing silica sol as claimed in claim 1, wherein the porous silica fine particles are formed by coating surfaces of silica-alumina based silica fine particles of sol with silica and then subjecting them to dealuminum treatment.

6. A process for preparing a titanium-containing silica sol (a1s) comprising (a1) titania fine particles having a mean particle diameter of 2 to 50 nm and porous silica fine particles having a mean particle diameter of 5 to 100 nm and a specific surface area, as determined by BET method, of not less than 300 m²/g and (b) a dispersion medium, which comprises:
mixing a titania sol comprising titania fine particles having a mean particle diameter of 2 to 50 nm and a dispersion medium (b); and a silica sol comprising porous silica fine particles having a mean particle diameter of 5 to 100 nm and a specific surface area, as determined by BET method, of not less than 300 m²/g and (b) a dispersion medium with each other.

7. A process for preparing a titanium-containing silica sol (a2s) comprising (a2) porous silica fine particles obtained by surface-modifying surfaces of porous silica fine particles having a mean particle diameter of 5 to 100 nm and a specific surface area, as determined by BET method, of not less than 300 m²/g with a titanate compound and (b) a dispersion medium, which comprises:
adding a titanate compound to a silica sol comprising porous silica fine particles having a mean particle diameter of 5 to 100 nm and a specific surface area, as determined by BET method, of not less than 300 m²/g and (b) a dispersion medium.

8. An antifouling film-forming composition comprising titanium-containing silica sol of claim 1 and, dispersed therein, a binder (c).

9. An ink-receiving layer-forming coating liquid comprising titanium-containing silica sol of claim 1 and, dispersed therein, a binder (c′).

10. The ink-receiving layer-forming coating liquid as claimed in claim 9, wherein:
100 parts by weight of the fine particles (a1) or the fine particles (a2) and 5 to 7 parts by weight of the binder (c′) are contained,
the ratio between the weight (W_{B}) of the dispersion medium (b) and the total weight (W_{A}+W_{C′}) of the fine particles (a1) or the fine particles (a2) and the binder (c′), W_{B}:(W_{A}+W_{C′}), is 99.9 to 50:0.1 to 50 (total: 100), and
the content of Si and Ti constituting the fine particles (a1) or the fine particles (a2) is in the range of 5 to 21,000 in terms of a SiO₂/TiO₂ weight ratio.

11. A process for preparing the ink-receiving layer-forming coating liquid of claim 9, comprising mixing a titanium-containing silica sol (a1s), which comprises the dispersion medium (b) and, dispersed therein, the fine particles (a1); the binder (c′); and, if necessary, the additional dispersion medium (b) with each other.

12. A process for preparing the ink-receiving layer-forming coating liquid of claim 9, comprising mixing a titanium-containing silica sol (a2s), which comprises the dispersion medium (b) and, dispersed therein, the fine particles (a2); the binder (c′); and, if necessary, the additional dispersion medium (b) with each other.

13. A recording substrate with an ink-receiving layer, having an ink-receiving layer that is formed on a substrate surface, said ink-receiving layer comprising:
(a1) titania fine particles having a mean particle diameter of 2 to 50 nm and porous silica fine particles having a mean particle diameter of 5 to 100 nm and a specific surface area, as determined by BET method, of not less than 300 m²/g, or
(a2) porous silica fine particles obtained by surface-modifying surfaces of porous silica fine particles having a mean particle diameter of 5 to 100 nm and a specific surface area, as determined by BET method, of not less than 300 m²/g, with a titanate compound.

14. A process for producing the recording substrate with an ink-receiving layer of claim 13, comprising:
(i) coating a substrate surface with an ink-receiving layer-forming coating liquid comprising a titanium-containing silica sol comprising:
(a) the following fine particles (a1) or the following fine particles (a2):
(a1) titania fine particles having a mean particle diameter of 2 to 50 nm and porous silica fine particles having a mean particle diameter of 5 to 100 nm and a specific surface area, as determined by BET method, of not less than 300 m²/g,
(a2) porous silica fine particles obtained by surface-modifying surfaces of porous silica fine particles having a mean particle diameter of 5 to 100 nm and a specific surface area, as determined by BET method, of not less than 300 m²/g, with a titanate compound,
(b) a dispersion medium, and
(c′) a binder dispersed therein;
(ii) and then drying the coating liquid.

15. A method for recycling a recording substrate, comprising performing printing on the recording substrate with an ink-receiving layer of claim 13 using an ink to form a printed letter or a printed image and then irradiating the printed letter or the printed image with ultraviolet light or bringing it into contact with an acid gas or ozone to decolor the printed letter or the printed image.

16. The titanium-containing silica sol as claimed in claim 2, wherein the content of Si and Ti constituting the titania fine particles and the porous silica fine particles (a1) or the porous silica particles (a2) obtained by surface modification with the titanate compound is in the range of 5 to 21,000 in terms of a SiO₂/TiO₂ weight ratio.

17. The titanium-containing silica sol as claimed in claim 2, wherein the surface electric charge of the porous silica fine particles is in the range of 10 to 150 μeq based on 1 g of the fine particles.

18. The titanium-containing silica sol as claimed in claim 2, wherein the porous silica fine particles are formed by coating surfaces of silica-alumina based silica fine particles of sol with silica and then subjecting them to dealuminum treatment.

19. An antifouling film-forming composition comprising titanium-containing silica sol of claim 2 and, dispersed therein, a binder (c).

20. An ink-receiving layer-forming coating liquid comprising titanium-containing silica sol of claim 2 and, dispersed therein, a binder (c′).

21. A process for preparing the ink-receiving layer-forming coating liquid of claim 10, comprising mixing a titanium-containing silica sol (a1s), which comprises the dispersion medium (b) and, dispersed therein, the fine particles (a1); the binder (c′); and, if necessary, the additional dispersion medium (b) with each other.

22. A process for preparing the ink-receiving layer-forming coating liquid of claim 10, comprising mixing a titanium-containing silica sol (a2s), which comprises the dispersion medium (b) and, dispersed therein, the fine particles (a2); the binder (c′); and, if necessary, the additional dispersion medium (b) with each other.

23. A process for producing the recording substrate with an ink-receiving layer as claimed in claim 14, wherein:
100 parts by weight of the fine particles (a1) or the fine particles (a2) and 5 to 7 parts by weight of the binder (c′) are contained,
the ratio between the weight (W_{B}) of the dispersion medium (b) and the total weight (W_{A}+W_{C′}) of the fine particles (a1) or the fine particles (a2) and the binder (c′), W_{B}:(W_{A}+W_{C′}), is 99.9 to 50:0.1 to 50 (total: 100), and
the content of Si and Ti constituting the fine particles (a1) or the fine particles (a2) is in the range of 5 to 21,000 in terms of a SiO₂/TiO₂ weight ratio.
